(19) United States
(12) Patent Application Publication
(10) Pub. No.: US 2014/0099452 A1
(43) Pub. Date: Apr. 10, 2014

(54) PEELABLE LAMINATED FILM, PEELABLE LAMINATED FILM ROLL, MANUFACTURING METHOD THEREOF, FILM, OPTICAL FILM, POLARIZING PLATE, MANUFACTURING METHOD OF POLARIZING PLATE AND LIQUID CRYSTAL DISPLAY DEVICE

(71) Applicant: FUJIFILM CORPORATION, Tokyo (JP)

(72) Inventors: Hiroyuki KAWANISHI, Kanagawa (JP); Katsumi SASATA, Kanagawa (JP); Hajime NAKAYAMA, Kanagawa (JP); Ryo SUZUKI, Kanagawa (JP); Nobutaka FUKAGAWA, Kanagawa (JP)

(73) Assignee: FUJIFILM CORPORATION, Tokyo (JP)

(21) Appl. No.: 14/101,660

(22) Filed: Dec. 10, 2013

Related U.S. Application Data
(63) Continuation of application No. PCT/JP2012/064833, filed on Jun. 8, 2012.

(30) Foreign Application Priority Data
Jun. 10, 2011 (JP) 2011-130722
Jul. 22, 2011 (JP) 2011-161327
Jun. 8, 2012 (JP) 2012-130516

(51) Int. Cl. B29C 41/32; B29D 11/00

(52) U.S. Cl. CPC B29C 41/32; B29D 11/00788
USPC 428/1.33; 264/2.7; 428/532; 428/212; 428/215; 524/560; 106/168.01; 524/612; 524/577

(57) ABSTRACT

Provided is a method for manufacturing a peelable laminated film including a layer A including cellulose ester and a layer B including a resin capable of a solution film-formation different from the cellulose ester, the layer A and the layer B having an adhesion of 5 N/cm or less, the method including: simultaneously or sequentially casting and laminating a dope A for forming the layer A, which includes cellulose ester and a solvent, and a dope B for forming the layer B, which includes a resin capable of a solution film-formation different from the cellulose ester and a solvent, on a casting support, peeling off a laminate of the dope A and the dope B from the casting support, and drying the laminate.

### CROSS REFERENCE TO RELATED APPLICATION

This is a continuation of International Application No. PCT/JP2012/064833 filed on Jun. 8, 2012, and claims priority from Japanese Patent Application No. 2011-130722 filed on Jun. 10, 2011, No. 2011-161327 filed on Jul. 22, 2011, and No. 2012-130516 filed on Jun. 8, 2012, the entire disclosures of which are incorporated herein by reference.

### TECHNICAL FIELD

The present invention relates to a peelable laminated film, a peelable laminated film roll, a manufacturing method thereof, a film, an optical film, a polarizing plate, a manufacturing method of the polarizing plate and a liquid crystal display device.

### BACKGROUND ART

A liquid crystal display device may be operated with low power consumption and made thinner, and thus, has been widely adopted as an image display device such as a TV set or a personal computer. In a liquid crystal display device, polarizing plates are provided on both sides of a liquid crystal cell, and the polarizing plate has a configuration in which transparent resin layers are sandwiched between both sides of a polarizing film on which iodine or a dye is adsorbed and oriented. The transparent resin layers are intended to protect a polarizer, and a cellulose ester film is commonly used.

Further, the cellulose ester film has high transmittance, and excellent adhesion with the polarizer is implemented by immersing the cellulose ester film in an alkali aqueous solution to saponify the surface thereof and make the surface hydrophilic, thereby manufacturing the polarizing plate.

As the liquid crystal display device has become recently popular, a thinner, larger screen or higher performance display has been required. In particular, members are required to be further thinned in the use of laptop PCs and small and medium-sized type computers (smart phones and slate PCs). For example, thinning is required even in a cellulose ester film which protects a polarizer of a polarizing plate used in a liquid crystal display device.

However, when a thin film of the cellulose ester film is trying to be manufactured by a solution film-formation, the discharge rate of a solution (hereinafter, a doping solution) including cellulose ester and a solvent is reduced, and thus, strength of the dope is decreased until the dope lands on a metal support in a casting die, and the thin film is easily affected by wind pressure fluctuation or mechanical vibration, thereby making it easy to generate thickness unevenness. In addition, since the solvent in the dope is also rapidly dried by thinning, it is difficult to perform leveling, and thus, there is also a problem in that a surface shape deteriorates due to deterioration in the smoothing effect of the thickness unevenness produced on the surface.

Further, even in a solution film-forming process of casting the dope on a metal support, peeling off the dope, and drying a film in a high volatile state while being conveyed, the rigidity of a thin film is reduced, thereby making it difficult to convey or handle the film to begin with.

Accordingly, even in the thin film formed by the solution casting film-formation an optical film having excellent surface shape and a good conveying property is required.

When a conveying property and the like are considered, an aspect in which a peelable protective film is attached to an optical film may be contemplated, and a method of simultaneously forming a film with an optical film is known (for example, Patent Document 1).

### RELATED ART DOCUMENT

### Patent Document

Patent Document 1: Japanese Patent No. 4517881

### DISCLOSURE OF INVENTION

### Problem to Be Solved

The method of Patent Document 1 discloses a method of solving a problem in that a part of a plasticizer added to an outer layer by a melt film formation is volatilized from a film, and thus, the film becomes non-uniform, and surface smoothness, curl, dimensional stability and retardation uniformity deteriorate. This method aims to prevent volatilization of an additive from the inside of the film, which occurs at the time of heat melting, and to solve the volatilization of the additive by subjecting a non-adherent peelable thermoplastic resin layer B on both sides of a layer A containing a meltable cellulose ester (cellulose acetate propionate, cellulose acetate butyrate and the like) and the plasticizer to co-extrusion of three layers or more, and is for only a laminate that protects a central film which is a basic layer.

Meanwhile, an object of the present invention is to provide a method for manufacturing a film which is a thin film and has excellent surface shape or retardation uniformity relatively easily and efficiently within the scope of the manufacturing technology in the related an without developing a manufacturing technology suitable for thinning, and the obtained film as an optical film which may be applied to a polarizing plate or a liquid crystal display device.

### Means for Solving the Problems

In the present invention, as a result of intensive studies considering the above problems, the present inventors have discussed a method for forming a film, which is capable of relatively easily obtaining a thin film within the scope of the manufacturing technology of a thick film by laminating layers having weak interlayer adhesion when laminated, and collectively thickening the film.

That is, the present invention is achieved by the following configuration.

(1) A method for manufacturing a peelable laminated film including a layer A including cellulose ester and a layer B including a resin capable of a solution film-formation which is different from the cellulose ester, the layer A and the layer B having an adhesion of 5 N/cm or less,

the method including: simultaneously or sequentially casting and laminating a dope A for forming the layer A, which includes at least the cellulose ester and a solvent, and a dope B for forming the layer B, which includes at least a resin capable of a solution film-formation different from the cellulose ester and a solvent, on a casting support, peeling off a laminate of the dope A and the dope B from the casting support, and drying the laminate.

(2) The method described in (1), in which a difference in SP value between cellulose ester and the resin capable of a solution film-formation different from the cellulose ester is 0.2 or more.

(3) The method described in (1) or (2), in which a three layer or more laminate is obtained by laminating any one layer or more of the dope A, the dope B and a dope C different from the dope A and the dope B on the laminate of the dope A and the dope B.

(4) The method described in any one of (1) to (3), in which the layer A has a film thickness of 5 μn to 60 μm and the peelable laminated film has a total film thickness of 20 μm to 200 μm.

(5) The method described in any one of (1) to (4), in which the cellulose ester used in the dope A is a cellulose acylate satisfying the following Equations (I) to (III).

1.0≦X+Y≦3.0 Equation (I)

0≦X≦3.0 Equation (II)

0≦Y≦2.6 Equation (III)

(In Equations (I) to (III), X is a degree of substitution of a hydroxyl group in a glucose unit of the cellulose acylate by an acetyl group, and Y is a degree of substitution of a hydroxyl group in a glucose unit of the cellulose acylate by an acyl group having 3 or more carbon atoms.)

(6) The method described in any one of (1) to (5), in which the resin capable of a solution film-formation different from the cellulose ester, which is used in the dope B, is a (meth)acrylic resin.

(7) The method described in (6), in which the (meth)acrylic resin used as a main component of the (meth)acrylic resin has a weight average molecular weight from 600,000 to 4,000,000.

(8) The method described in any one of (1) to (7), in which at least any one of the dopes, A, B and C includes a polarizer durability enhancer, and the polarizer durability enhancer is a compound represented by following Formula (1).

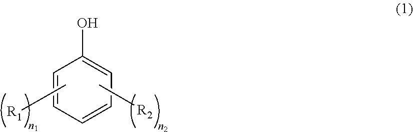

in Formula (1), R₁ represents a hydrogen atom or a substituent and R₂ is a substituent represented by the following Formula (1-2); n₁ represents an integer of 0 to 4, and each R₁ may be the same or different when n₁ is 2 or more; and n₁ represents an integer of 1 to 5, and each R₂ may be the same or different when n₂ is 2 or more.

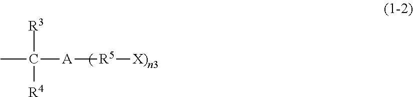

In Formula (1-2), A represents a substituted or unsubstituted aromatic ring; R³ and R⁴ each independently represent a hydrogen atom, an alkyl group having 1 to 5 carbon atoms, or a substituent represented by Formula (1-3); R⁵ represents a single bond or an alkylene group having 1 to 5 carbon atoms; X represents a substituted or unsubstituted aromatic ring; and n3 represents an integer of (to 10, and when n3 is 2 or more, each R⁵ may be the same or different, and each X may be the same or different.,

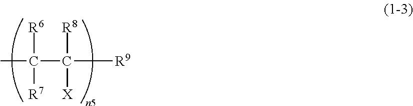

In Formula (1-3), X represents a substituted or unsubstituted aromatic ring; R⁶, R⁷, R⁸ and R⁹ each independently represent a hydrogen atom or an alkyl group having 1 to 5 carbon atoms; and n5 represents an integer of 1 to 11, and when n5 is 2 or more, each R⁶ may be the same or different, each R⁷ may be the same or different, each R⁸ may be the same or different, each R⁹ may be the same or different and each X may be the same or different.

(9) The method described in any one of (1) to (8), in which a coating layer is formed on at least one surface of the laminate.

(10) A method for manufacturing a peelable laminated film roll, including: winding a peelable laminated film manufactured by the manufacturing method described in any one of (1) to (8).

(11) A method for manufacturing a film, including: peeling off a part of layers in a laminate of a peelable laminated film manufactured by the manufacturing method described in any one of (1) to (8), and winding each peeled layer as a separate film.

(12) An optical film obtained by peeling off the layer A from a peelable laminated film by the manufacturing method described in any one of (1) to (11).

(13) A peelable laminated film including: a laminate including a layer A including cellulose ester and a layer B including a resin capable of a solution film-formation which is different from the cellulose ester, the layer A and the layer B having an adhesion of 5 N/cm or less.

(14) The peelable laminated film described in (13), in which a difference in SP value between the layer B and the layer A is 0.2 or more.

(15) The peelable laminated film described in (13) or (14), in which the laminate including the layer A and the layer B is a three or more-layer laminate including at least a plurality of either the layer A or the layer B, or a three or more-layer laminate including a layer C different from the layer A and the layer B.

(16) The peelable laminated film described in (15), in which all of the three or more layers are different.

(17) The peelable laminated film described in any one of (13) to (16), in which the layer A has a film thickness of 5 μm to 60 μm and the peelable laminated film has a total film thickness of 20 μm to 200 μm.

(18) The peelable laminated film described in any one of (13) to (17), in which the layer B is a conveying support.

(19) The peelable laminated film described in any one of (13) to (18), further including a coating layer on at least one surface of the laminate.

(20) A film obtained by peeling off any one layer of the laminate from the peelable laminated film described in any one of (13) to (19).

(21) A method for manufacturing a polarizing plate, including: forming the peelable laminated film described in any one of (13) to (19) as a long-sized peelable laminated and capable of being peeled off onto an inner layer and an outer layer of a front and back surface, peeling off the outer layer of the front and back surface of the peelable laminated film from the inner layer, wherein a polarizer is sandwiched with the outer layer of the front and back surface.

(22) A polarizing plate including an outer layer of the peelable laminated film described in any one of (13) to (19), which is formed as a long-sized film and peelable onto an inner layer and an outer layer of a front and back surface as a protective film of a polarizer.

(23) A liquid crystal display device using the film described in (12) or (20) or the polarizing plate described in (22).

### Effects of Invention

According to the present invention, it is possible to obtain a thin film in which a conveying property, a surface shape of a film, and retardation uniformity are secured.

### BRIEF DESCRIPTION OF DRAWINGS

FIG. 1 is a schematic view illustrating an example of a band casting apparatus.

FIG. 2 is a schematic view illustrating an example of a drum casting apparatus.

FIG. 3 is a schematic view illustrating an example of preparing a polarizing plate with a peelable laminate of the present invention.

### DETAILED DESCRIPTION OF EMBODIMENTS OF THE INVENTION

Hereinafter, a peelable laminated film of the present invention and the manufacturing method thereof, and a polarizing plate and a liquid crystal display device using an optical film obtained by being peeled off from the peelable laminated film of the present invention will be described in detail.

The explanation of constituent elements described hereinafter may be made based on the representative embodiment of the present invention, but the present invention is not limited to such an embodiment. Further, in the present specification, a numerical range represented by using “to” denotes a range including numerical values described before and after “to” as a lower limit and an upper limit.

[Peelable Laminated Film]

A peelable laminated film of the present invention includes a laminate of a layer A including cellulose ester and a layer B including a resin capable of a solution film-formation which is different from the cellulose ester, the layer A and the layer B having an adhesion of 5 N/cm or less.

Further, a film and an optical film of the present invention are obtained by being peeled off from the peelable laminated film, and when simply described as the “film” in the present specification, the “film” is defined as including both (the film and the optical film).

Hereinafter, preferred aspects of the peelable laminated film of the present invention will be described.

<Layer Configuration of Peelable Laminated Film>

(Thickness of Layer A)

The laminate of the peelable laminated film of the present invention includes a layer A including cellulose ester and a layer B containing a resin capable of a solution film-formation which is different from the cellulose ester, the layer A and the layer B having an adhesion of 5 N/cm or less. By the configuration, each layer of the peelable laminated film of the present invention has characteristics suitable as a thin film under conditions of manufacturing a thick film. Further, the adhesion of the layer A and the layer B is preferably 0.1 N/cm to 2.0 N/cm, more preferably 0.1 N/cm to 1.8 N/cm, still more preferably 0.2 N/cm to 1.0 N/cm, and particularly preferably 0.2 N/cm to 0.7 N/cm. When interlayer adhesion is extremely small, the peelable laminated film is peeled off while being conveyed in the film-formation process, thereby causing troubles in manufacturing. On the other hand, when the interlayer adhesion is extremely large, deterioration in surface shape such as peeling unevenness occurs, which is not preferred.

The total film thickness of the laminate including the layer A and the layer B is preferably 20 μm to 200 μm, more preferably 20 μm to 180 μm, particularly preferably 30 μm to 150 μm, and most preferably 40 μm to 100 μm. When the total film thickness is extremely small, there is concern over deterioration in surface shape and the like from the viewpoint of film-formation suitability, and when the total film thickness is extremely large, there is concern over deterioration in handling property and the like. When the total film thickness of the laminate is 40 μm to 100 μm, the thickness is close to a thickness of a laminate currently distributed as a cellulose-based film, and thus, it is also preferred in that various technologies such as conveying or processing, or apparatuses are very easily diverted or introduced.

Further, a film thickness of a single body of the layer A may be set to a desired thickness, is preferably 5 μn to 60 μm, more preferably 8 μm to 50 μm, still more preferably 8 μm to 30 μm, and particularly preferably 10 μm to 25 μm.

(Thickness of Layer B)

A film thickness of a single body of the layer B may be set to a desired thickness like the layer A.

However, when the layer B is manufactured as a conveying support, the layer B needs to have mechanical performance appropriate for aiding in supporting the other layers, and thus preferably has a certain thickness.

(Lamination Aspect)

The peelable laminated film of the present invention may further include a layer C including a resin capable of a solution film-formation different from the layer A or layer B other than the layer A and the layer B, and may also have an alternating layer structure including each of the layer A, the layer B and the layer C in plural.

(Film Width)

The peelable laminated film of the present invention and a film obtained by being peeled off from the peelable laminated film have a film width of preferably 400 mm to 2,500 mm, more preferably 1,000 mm to 2,500 mm, particularly preferably 1,500 mm to 2,500 mm, and more particularly preferably 1,800 mm to 2,500 mm.

Next, details and preferred aspects of components included in each layer of the peelable laminated film of the present invention will be described.

Hereinafter, the configurations of the layer A and the layer B will be sequentially described.

<Layer A>

In the peelable laminated film of the present invention, the layer A includes cellulose ester, preferably cellulose acylate as a main component. Further, the main component means a component having the largest content (% by mass) among components constituting a layer.

(Thickness)

Preferred aspects of the thickness of the layer A are the same as those described in describing the layer configuration of the present invention.

(Cellulose Acylate)

The cellulose acylate used in the present invention is not particularly determined. Examples of the cellulose as a raw material include cotton linter, wood pulp (broad leaf pulp, and needle leaf pulp) and the like, a cellulose acylate obtained from any raw material cellulose may be used, and mixtures of such cellulose acylate may be also used in some cases. Detailed descriptions on these raw material celluloses may be found in, for example, “Lecture on Plastic Materials (17) Cellulose Resins” written by Marusawa, Uda, The NIKKAN KOGYO SHIMBUN, Ltd. (published in 1970), or Japan Institute of Invention and Innovation, Open Technical Report No. 2001-1745 (pages 7 and 8).

The cellulose ester used in the present invention has a total degree of substitution of an acyl group of preferably 1.0 to 3.0.

Further, it is preferred that the cellulose ester (preferably cellulose acylate) used in the present invention satisfies the following conditions when the total degree of substitution of an acyl group, a degree of substitution (degree of substitution of a hydroxyl group in a glucose unit by an acetyl group) of an acyl group (an acetyl group) having 2 carbon atoms, and a degree of substitution (degree of substitution of a hydroxyl group in a glucose unit by an acetyl group having 3 or more carbon atoms) of an acyl group having 3 carbon atoms are defined as X+Y, X and Y, respectively. By setting the degree of substitution to the following ranges, it is possible to obtain the layer A excellent from the viewpoint of adhesion with adjacent layers, peelability from a casting support during casting, and reduction in curl of a film.

1.0≦X+Y≦3.0

0≦X≦3.0

0≦Y≦2.6

Further, the cellulose ester is more preferably a cellulose acylate-based resin satisfying the following conditions.

2.0≦X+Y≦3.0

1.5≦X≦3.0

0≦Y≦2.0

The total degree of acetyl substitution (X+Y) is more preferably 2.8≦X+Y≦3.0, and still more preferably 2.85≦X+Y≦3.0.

It is particularly preferred that the cellulose acylate used in the present invention is at least one selected from cellulose acetate, cellulose acetate propionate, cellulose acetate butyrate, cellulose acetate benzoate, cellulose propionate, and cellulose butyrate. Among them, as the cellulose acylate, cellulose acetate and cellulose acetate propionate are more preferred; and cellulose acetate is still more preferred.

Further, the degree of substitution of an acetyl group or the degrees of substitution of other acyl groups may be obtained by the method described in the ASTM-D817-96.

A weight average molecular weight (Mw) of the cellulose acylate used in the present invention is preferably 75,000 or more, more preferably in a range of 75,000 to 300,000, still more preferably in a range of 100,000 to 240,000, and particularly preferably 160,000 to 240,000, from the viewpoint of adhesion with a resin (particularly, a (meth)acrylic resin) capable of a solution film-formation different from the cellulose ester included in the layer B. When the weight average molecular weight (Mw) of the cellulose acylate is 75,000 or more, an effect of improving self-film formability or adhesion of a cellulose acylate-based resin layer itself is exhibited, which is preferred. In the present invention, two or more cellulose acylate resins may be mixed and used.

<Layer B>

In the peelable laminated film of the present invention, the layer B contains a resin capable of a solution film-formation different from the cellulose ester. In the present specification, examples of the resin capable of a solution film-formation different from the cellulose ester include a (meth)acrylic resin (also referred to as “a (meth)acrylic resin” or “a (meth)acrylic acid-based resin”), a polycarbonate-based resin, a polystyrene-based resin, a cycloolefin-based resin, and the like, and the resin may be selected from these resins and mixed resins of a plurality of these resins.

Further, the layer B is laminated so as to have peelability with an adhesion of 5 N/cm or less with the layer A.

In order to impart peelability, it is preferred that the compositions of the layer A and the layer B do not have compatibility, an SP value (solubility parameter) may be used as an index, and the B layer may be formed by appropriately selecting the resin or the composition thereof.

In order to impart peelability in the present invention, a difference in SP value between the layer A and the layer B may be adjusted so as to be 0.2 or more by selecting a material used in each layer. Further, an SP value of a layer corresponds to an SP value of a resin substantially used in the layer. Accordingly, in the present invention, the difference in SP value between the resin (cellulose ester) used in the layer A and the resin used in the layer B is preferably 0.2 or more. The difference in SP value is more preferably 0.5 to 3.5, still more preferably 1.0 to 3.5, and most preferably 1.5 to 3.5. The dissolution parameter indicates that described in for example, in J. Brandrup, E. H, et al., “Polymer Handbook (4th Edition), VII/671 to VII/714”.

Further, the (meth)acrylic resin is a concept which includes both a methacrylic resin and an acrylic resin. In addition, the (meth)acrylic resin also includes a derivative of acrylate/methacrylate, and particularly a (co)polymer of acrylate ester/methacrylate ester.

((Meth)Acrylic Resin)

A repeating structural unit of the (meth)acrylic resin is not particularly limited. It is preferred that the (meth)acrylic resin has a repeating structural unit derived from a (meth)acrylic acid ester monomer as a repeating structural unit.

The (meth)acrylic resin may include a repeating structural unit, which is constituted by polymerizing at least one selected from a hydroxyl group-containing monomer, an unsaturated carboxylic acid and a monomer represented by the following Formula (201) as the repeating structural unit.

CH₂═C(X)R²⁰¹ Formula (201)

(In the formula, R²⁰¹ represents a hydrogen atom or a methyl group, X represents a hydrogen atom, an alkyl group having 1 to 20 carbon atoms, an aryl group, a —CN group, a —CO—R²⁰² group or a —O—CO—R²⁰³ group, and R²⁰² and R²⁰³ represent a hydrogen atom or an organic residue having 1 to 20 carbon atoms.)

The (meth)acrylic acid ester is not particularly limited, but examples thereof include acrylic acid ester such as methyl acrylate, ethyl acrylate, n-butyl acrylate, isobutyl acrylate, t-butyl acrylate, cyclohexyl acrylate and benzyl acrylate; methacrylic acid ester such as methyl methacrylate, ethyl methacrylate, propyl methacrylate, n-butyl methacrylate, isobutyl methacrylate, t-butyl methacrylate, cyclohexyl methacrylate and benzyl methacrylate; and the like, and these may be used either alone or in combination of two or more thereof. Among them, methyl methacrylate is particularly preferred from the viewpoint of excellent heat resistance and transparency.

When the (meth)acrylic acid ester is used, the content thereof used in the monomer component in a polymerization process is preferably 10 to 100% by mass, more preferably 20 to 100% by mass, still more preferably 40 to 100% by mass, and particularly preferably 50 to 100% by mass in order to sufficiently exhibit the effect of the present invention.

The hydroxyl group-containing monomer is not particularly limited, but examples thereof include 2-(hydroxyalkyl)acrylic acid ester such as α-hydroxymethylstyrene, α-hydroxyethylstyrene and methyl 2-(hydroxyethyl)acrylate; 2-(hydroxyalkyl)acrylic acid such as 2-(hydroxyethyl)acrylic acid; and the like, and these may be used either alone or in combination of two or more thereof.

When the hydroxyl group-containing monomer is used, the content thereof in the monomer component used in the polymerization process is preferably 0 to 30% by mass, more preferably 0 to 20% by mass, still more preferably 0 to 15% by mass, and particularly preferably 0 to 10% by mass in sufficiently exhibiting the effect of the present invention.

Examples of the unsaturated carboxylic acid include acrylic acid, methacrylic acid, crotonic acid, α-substituted acrylic acid, α-substituted methacrylic acid and the like, and these may be used either alone or in combination of two or more thereof. Among them, acrylic acid and methacrylic acid are particularly preferred in view of sufficiently exhibiting the effect of the present invention.

When the unsaturated carboxylic acid is used, the content thereof used in the monomer component in the polymerization process is preferably 0 to 30% by mass, more preferably 0 to 20% by mass, still more preferably 0 to 15% by mass, and particularly preferably 0 to 10% by mass in order to sufficiently exhibit the effect of the present invention.

Examples of the monomer represented by Formula (201) include styrene, vinyl toluene, α-methyl styrene, acrylonitrile, methylvinyl ketone, ethylene, propylene, vinyl acetate and the like, and these may be used either alone or in combination of two or more thereof. Among them, styrene and α-methyl styrene are preferred in view of sufficiently exhibiting the effect of the present invention.

When the monomer represented by Formula (201) is used, the content thereof used in the monomer component in the polymerization process is preferably 0 to 30% by mass, more preferably 0 to 20% by mass, still more preferably 0 to 15% by mass, and particularly preferably 0 to 10% by mass in order to sufficiently exhibit the effect of the present invention.

The monomer component may form a lactone ring after the polymerization. In that case, it is preferred to obtain a polymer having a hydroxyl group and an ester group in a molecular chain thereof by polymerizing the monomer component

A form of a polymerization reaction for obtaining a polymer having a hydroxyl group and an ester group in a molecular chain thereof by polymerizing the monomer component is preferably a polymerization form using a solvent, and particularly preferably a solution polymerization.

In the case of a polymerization form using a solvent, a polymerization solvent is not particularly limited, but examples thereof include aromatic hydrocarbon-based solvents such as toluene, xylene and ethylbenzene; ketone-based solvents such as methyl ethyl ketone and methyl isobutyl ketone; ether-based solvents such as tetrahydrofuran; and the like, and these may be used either alone or in combination of two or more thereof.

Further, in the manufacturing method of the present invention, since the layer B is formed by dissolving a (meth)acrylic resin in an organic solvent and performing a solution casting, the organic solvent during the synthesis of the (meth)acrylic resin is less limited than that when a melt film formation is performed, and the polymer may be synthesized using an organic solvent having a high boiling point.

During the polymerization reaction, a polymerization initiator may be added, if necessary. The polymerization initiator is not particularly limited, but examples thereof include organic peroxides such as cumene hydroperoxide, diisopropylbenzene hydroperoxide, di-t-butyl peroxide, lauroyl peroxide, benzoyl peroxide, t-butylperoxyisopropyl carbonate, and t-amyl peroxy-2-ethylhexanoate; azo compounds such as 2,2′-azobis(isobutyronitrile), 1,1′-azobis(cyclohexanecarbonitrile) and 2,2′-azobis(2,4-dimethylvaleronitrile); and the like, and these may be used either alone or in combination of two or more thereof. An amount of the polymerization initiator used may be set appropriately according to a combination of monomers used, reaction conditions and the like, and is not particularly limited.

It is possible to adjust the weight average molecular weight of the polymer by adjusting the amount of the polymerization initiator.

When polymerization is carried out, a concentration of a polymer produced in a polymerization reaction mixture is preferably controlled to be 50% by mass or less in order to suppress gelation of a reaction liquid. Specifically, when the concentration of the polymer produced in the polymerization reaction mixture exceeds 50% by mass, it is preferred that the concentration is controlled to be 50% by mass or less by appropriately adding the polymerization solvent to the polymerization reaction mixture. The concentration of the polymer produced in the polymerization reaction mixture is more preferably 45% by mass or less, and still more preferably 40% by mass or less.

A form of appropriately adding the polymerization solvent to the polymerization reaction mixture is not particularly limited, and the polymerization solvent may be added continuously or intermittently. By controlling the concentration of the polymer produced in the polymerization reaction mixture as described above, the gelation of the reaction liquid may be more sufficiently suppressed. The polymerization solvent to be added may be a solvent which is the same as or different from that used at the time of the initial preparation for the polymerization reaction, and may be the different kind of solvent, but it is preferred to use the same solvent as that used at the time of the initial preparation for the polymerization reaction. Further, the polymerization solvent to be added may be a single solvent, and may be a mixture of two or more kinds of solvents.

The polymer having a hydroxyl group and an ester group in a molecular chain thereof by polymerizing the monomer component obtained during the polymerization process has a weight average molecular weight of preferably 600,000 to 4,000,000, more preferably in a range of 800,000 to 2,000,000, still more preferably in a range more than 1,000,000 and 2,000,000 or less, and particularly preferably more than 1,000,000 and 1,800,000 or less.

As the (meth)acrylic resin, it is also possible to use a (meth)acrylic resin in which an alicyclic alkyl group is contained as a copolymerization component, or a cyclic structure is formed in a molecular main chain by intermolecular cyclization. Examples of the (meth)acrylic resin in which a cyclic structure is formed in a molecular main chain include a (meth)acrylic thermoplastic resin including a lactone ring-containing polymer as a preferred aspect, and the preferred resin composition or synthesis method thereof is described in Japanese Patent Application Laid-Open No. 2006-171464. Further, another preferred aspect is a resin containing glutaric anhydride as the copolymerization component, and the copolymerization component and the specific synthesis method are described in Japanese Patent Application Laid-Open No. 2004-070296.

A combination of the weight average molecular weight (referred to as a mass average molecular weight in some cases) of the resin which forms the layer B and the weight average molecular weight of the resin which forms the layer A is not particularly limited, but the weight average molecular weight may be appropriately selected so as to be optimal during the film-forming process.

Here, as the (meth)acrylic resin, a (meth)acrylic resin having a molecular weight of approximately 100,000 is generally used in the film formation. Specifically, in the melt film formation, it is impossible to form a high molecular weight (meth)acrylic resin film to begin with. Further, the (meth)acrylic resin film may be formed even by a solution film-formation, but in that case, a dope having a viscosity enough to be easily solution-cast need to be prepared. When the (meth)acrylic resin is a (meth)acrylic resin having a molecular weight of 300,000 or more, a dope having high casting suitability is easily prepared, and thus, the (meth)acrylic resin is used in the film formation in the related art.

In contrast, in order to implement co-casting with the layer A of cellulose ester in the peelable laminated film of the present invention, it is preferred that the peelable laminated film is formed using a (meth)acrylic resin having a larger weight average molecular weight. That is, in the resin which forms the layer B used in the peelable laminated film of the present invention, particularly from the viewpoint of brittleness and self-film formality as an optical film, the weight average molecular weight (Mw) is preferably 600,000 to 4,000,000), more preferably in a range 800,000 to 2,000,000, still more preferably in a range more than 1,000,000 and 2,000,000 or less, and particularly preferably in a range more than 1,000,000 and 1,800,000 or less. When a (meth)acrylic resin is used, a polymerization average molecular weight of the (meth)acrylic resin as a main component thereof is preferably 600,000 to 4,000,000, and more preferably 800,000 to 2,000,000. Further, the main component means a component having the largest content (% by mass) among components constituting a layer.

The weight average molecular weight of the resin which forms the layer B may be measured by gel permeation chromatography.

It is particularly preferred that the resin which forms the layer B has a weight average molecular weight from 800,000 to 2,000,000, and is a (meth)acrylic resin including a methylmethacrylate unit in an amount of 50% by mass or more in a molecule thereof.

The resin which forms the layer B has a glass transition temperature (Tg) of preferably 90° C. or more, more preferably 100° C. or more, and still more preferably 110° C. or more.

It is preferred that peel force of the layer A and the layer B is adjusted by appropriately adding an additive to be described below to the layer B, and with respect to a balance between hydrophilicity and hydrophobicity of a main polymer resin in the layer A and the layer B, the peel force is controlled by controlling hydrophilicity and hydrophobicity of the additive to be added. Further, the peel force may be appropriately adjusted by changing the solvent composition of the solvent used.

(Polycarbonate-Based Resin)

The layer B in the present invention may be used by adding an additive to a commercially available polycarbonate resin such that the peel force or toughness is controlled.

(Polystyrene-Based Resin)

The layer B in the present invention may be used by adding an additive to a commercially available polystyrene-based resin such that the peel force or toughness is controlled.

(Cyclic Polyolefin-Based Resin)

In the present invention, a cyclic polyolefin resin may be used in the layer B. Here, the cyclic polyolefin-based resin (also referred to as a cyclic polyolefin or a cyclic polyolefin polymer) indicates a polymer resin having a cyclic olefin structure.

Examples of the polymer resin having a cyclic olefin structure used in the present invention include (1) norbornene-based polymers (2) polymers of single-ring cyclic olefins, (3) polymers of cyclic conjugated dienes, and (4) vinyl alicyclic hydrocarbon polymers, hydrides of (1) to (4) and the like.

Preferred polymers in the present invention are addition (co)polymer cyclic polyolefins including at least one or more repeating units represented by the following Formula (II) and addition (co)polymer cyclic and addition (co)polymer cyclic polyolefins further including at least one or more repeating units represented by Formula (1), if necessary. Further, ring opening (co)polymers including at least one cyclic repeating unit represented by Formula (III) may also be suitably used.

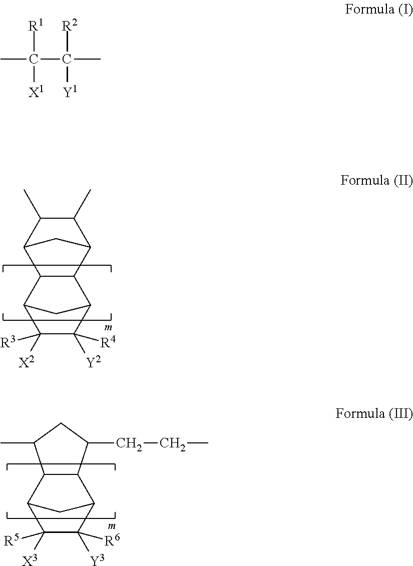

In the formula, m represents an integer of 0 to 4. R¹ to R⁶ represent a hydrogen atom or a hydrocarbon group having 1 to 10 carbon atoms, and X¹ to X³ and Y¹ to Y³ represent a hydrogen atom, a hydrocarbon group having 1 to 10 carbon atoms, a halogen atom, a hydrocarbon group having 1 to 10 carbon atoms, which is substituted with a halogen atom, —(CH₂)ₙCOOR¹¹, —(CH)ₙOCOR¹², —(CH₂)NCO, —(CH₂)ₙNO₂, —(CH₂)ₙCN, —(CH₂)ₙCONR¹³R¹⁴, —(CH₂)ₙNR¹³R¹⁴, —(CH₂)OZ, —(CH₂)ₙW, or (—CO)₂O or (—CO)₂NR¹⁵ formed by X¹ and Y¹ or X² and Y² or X³ and Y³. Further, R¹¹, R¹², R¹³, R¹⁴ and R¹⁵ represent a hydrogen atom or a hydrocarbon group having 1 to 20 carbon atoms, Z represents a hydrocarbon group or a hydrocarbon group substituted with halogen, W represents SiR¹⁶ₚD₃₋ₚ (in which R¹⁶ represents a hydrocarbon group having 1 to 10 carbon atoms, D represents a halogen atom, —OCOR¹⁶ or —OR¹⁶, and p represents an integer of 0 to 3), and n represents an integer of 0 to 10.

The introduction of a functional group having a high polarity into the substituents X¹ to X³ and Y¹ to Y³ makes it possible to increase retardation in a thickness-direction (Rth) of the optical film and enhance the developability of an in-plane retardation (Re). A Re value of a film having a large Re developability may be increased by stretched the film during the film formation.

As disclosed in Japanese Patent Application Laid-Open Nos. H1-240517, H7-196736, Sho60-26024, Sho62-19801, 2003-1159767, 2004-309979 or the like, the norbornene-based polymer hydride is prepared by subjecting a polycyclic unsaturated compound to addition polymerization or metathesis ring-opening polymerization and then to hydrogenation. In the norbornene-based polymer used in the present invention, R⁵ and R⁶ are preferably a hydrogen atom or —CH₃, X³ and Y³ are preferably a hydrogen atom, Cl and —COOCH₃, and the other groups are appropriately selected. As for the norbornene-based resins, a product under the trade name of Arton 0 or Arton F is released by JSR Corp., and a product under the trade name of Zeonor ZF4, Zeonor ZF16, Zeonex 250 or Zeonex 280 is commercially available from ZEON Corporation are commercially available, and thus these products may be used.

The norbornene-based addition (co)polymers are disclosed in Japanese Patent Application Laid-Open No. H10-7732, Japanese Patent Application National Publication No. 2002-504184, US Patent Publication No. 2004229157A1, WO2004/070463A1, and the like. The norbornene-based addition copolymer is obtained by addition-polymerizing norbornene-based polycyclic unsaturated compounds with each other. In addition, if necessary, a norbornene-based polycyclic unsaturated compound may be addition-polymerized with ethylene, propylene, and butene; a conjugated diene such as butadiene and isoprene; a non-conjugated diene such as ethylidene norbornene; or a linear diene compound such as acrylonitrile, acrylic acid, methacrylic acid, anhydrous maleic acid, acrylic acid ester, methacrylic acid ester, maleimide, vinyl acetate, and vinyl chloride. The norbornene-based addition (co)polymers are released under the trade name of APEL from Mitsui Chemical Inc., including grades different in the glass transition temperatures (Tg), such as, for example, APL8008T (Tg 70° C.), APL6013T (Tg 125° C.) or APL6015T (Tg 145° C.). Pellets are released under the trade name of TOPAS8007, TOPAS6013, TOPAS601S and the like from Polyplastics Co., Ltd. Further, Appear 3000 is commercially available from Ferrania Inc.

In the present invention, the glass transition temperature (Tg) of the cyclic polyolefin is not particularly limited, and for example, a cyclic polyolefin having a high Tg from 200° C. to 400° C. may also be used.

(Other Thermoplastic Resins which May be Included in Layer B)

The layer B in the present invention may include other thermoplastic resins other than the aforementioned resin. The other thermoplastic resins are not particularly limited without departing from the spirit of the present invention, but a thermoplastic resin thermodynamically compatible is preferred in view of enhancing mechanical strength or a desired physical property.

Examples of the other thermoplastic resins include olefin-based polymers such as polyethylene, polypropylene, ethylene-propylene copolymers and poly(4-methyl-pentene); halogen-containing polymers such as vinyl chloride and chlorinated vinyl resins; acrylic polymers such as polymethylmethacrylate; styrene-based polymers such as polystyrene, styrene-methyl methacrylate copolymers, styrene-acrylonitrile copolymers and acrylonitrile-butadiene-styrene block copolymers; polyesters such as polyethylene terephthalate, polybutylene terephthalate and polyethylene naphthalate; polyamides such as nylon 6, nylon 66 and nylon 610; polyacetal; polycarbonate; polyphenylene oxide; polyphenylene sulfide; polyether ether ketone; polysulfone; polyether sulfone; polyoxybenzylene; polyamideimide; rubber polymers such as an ABS resin or an ASA resin obtained by blending polybutadiene-based rubber with acrylic rubber; and the like. It is preferred that the rubber polymer has, on a surface, a graft portion with a composition, which is compatible with the lactone ring polymer of the present invention, and further, the average particle diameter of the rubber polymer is preferably 100 nm or less and more preferably 70 nm or less from the viewpoint of enhancing transparency when the polymer is formed into a film.

As the thermoplastic resin that is thermodynamically compatible with the resin which forms the layer B, a copolymer including a cyanized vinyl-based monomer unit and an aromatic vinyl-based monomer unit, specifically, an acrylonitrile-styrene-based copolymer, a polyvinyl chloride resin, or a polymer containing 50% by mass or more of methacrylic esters may be used. Among them, when an acrylonitrile-styrene-based copolymer is used, it is possible to easily obtain the layer B having a glass transition temperature of 120° C. or more, a phase difference of 20 nm or less per 100 μm in a plane direction, and a total light transmittance of 85% or more.

When the layer B in the present invention contains the other thermoplastic resins, the content ratio between the resin which forms the layer B and the other thermoplastic resins is preferably 60 to 99:1 to 40% by mass, more preferably 70 to 97:3 to 30% by mass, and still more preferably 80 to 95:5 to 20% by mass. However, when the layer B in the present invention is also used as an optical film, it is preferred that the layer B does not contain the other thermoplastic resins as long as the compatibility is not high from the viewpoint of a polymer blend.

(Residual Solvent Amount)

It is preferred that the peelable laminated film of the present invention is formed by lamination caused by co-casting or sequential casting by a manufacturing method of the present invention to be described below. By forming the layer B which contains a resin capable of a solution film-formation different from cellulose ester by the solution film-formation as described above, a surface shape of a surface of the layer A may be improved more than when a layer containing the resin capable of a solution film-formation different from cellulose ester is formed by a melt film formation.

<Additives>

The peelable laminated film of the present invention may contain an additive, for example, a plasticizer, a brittleness improving agent, an interlayer peeling promoter between the layer A and the layer B, an antistatic agent, a filler, a UV absorber, a free acid, a radical trapping agent, a particle and the like along with one or two or more thermoplastic resins as a main raw material in each of the layer B and the layer A, without departing from the spirit of the present invention.

Hereinafter, the additive which may be added to the peelable laminated film of the present invention will be described.

(Brittleness Improving Agent)

In the peelable laminated film of the present invention, the layer B may include a brittleness improving agent. The brittleness improving agent is not particularly limited, but examples thereof include the following compounds.

(Compounds Having Repeating Unit)

The brittleness improving agent in the present invention is preferably a compound having a repeating unit. Examples of the compound having a repeating unit include a condensate or an adduct, preferred examples of the condensate include a condensate of polyhydric alcohol and polybasic acid, a condensate of polyhydric ether alcohol and polybasic acid, and a condensate of a condensate of polyhydric alcohol and polybasic acid and an isocyanate compound, and examples of the adduct include an adduct of acrylic acid ester and an adduct of methacrylic acid ester. Further, it is also possible to use a polyether-based compound, a polyurethane-based compound, a polyether polyurethane-based compound, a polyamide-based compound, a polysulfone-based compound, a polysulfonamide-based compound, and a compound having a number average molecular weight of 600 or more as the other polymer-based compound.

At least one of them is preferably a condensate of polyhydric alcohol and polybasic acid, a condensate of polyhydric ether alcohol and polybasic acid, an adduct of acrylic acid ester or an adduct of methacrylic acid ester, more preferably a condensate of polyhydric alcohol and polybasic acid or an adduct of acrylic acid ester, and still more preferably a condensate of polyhydric alcohol and polybasic acid.

(Plasticizer)

In the present invention, a plasticizer may be used in order to enhance dimensional stability and enhance moisture resistance by imparting flexibility to the peelable laminated film.

Examples of the plasticizer preferably added include low-molecular weight to oligomeric compounds having a molecular weight approximately from 190 to 5,000 in the range of the aforementioned physical properties, and for example, phosphoric acid ester, carboxylic acid ester, polyol ester and the like are used.

Examples of the phosphoric acid ester include triphenyl phosphate (TPP), tricresyl phosphate, cresyl diphenyl phosphate, octyl diphenyl phosphate, biphenyl diphenyl phosphate, trioctyl phosphate, tributyl phosphate and the like. Preferred are triphenyl phosphate and biphenyl diphenyl phosphate.

Representative examples of the carboxylic acid ester include phthalic acid ester and citric acid ester. Examples of the phthalic acid ester include dimethyl phthalate, diethyl phthalate, dibutyl phthalate, dioctyl phthalate, diphenyl phthalate, diethyl hexyl phthalate and the like. Examples of the citric acid ester include O-acetyl triethyl citrate, O-acetyl tributyl citrate, acetyl triethyl citrate, acetyl tributyl citrate and the like.

These preferred plasticizers are a liquid at 25° C. except for TPP (melting temperature: about 50° C.) and also have a boiling point of 250° C. or more.

Other examples of the carboxylic acid ester include butyl oleate, methyl acetyl ricinoleate, dibutyl sebacate and various trimellitic acid esters. Examples of a glycolic acid ester include triacetin, tributyrin, butyl phthalyl butyl glycolate, ethyl phthalyl ethyl glycolate, methyl phthalyl ethyl glycolate, butyl phthalyl butyl glycolate, methyl phthalyl methyl glycolate, propyl phthalyl propyl glycolate, butyl phthalyl butyl glycolate, octyl phthalyl octyl glycolate and the like.

Further, plasticizers described in Japanese Patent Application Laid-Open Nos. H5-194788, S60-250053, H4-227941, H6-16869, H5-271471, H7-286068, H5-5047, H11-80381, H7-20317, H8-57879, H10-152568 and H10-120824 are also preferably used. According to these patent documents, not only examples of the plasticizer but also preferred utilization methods or properties of the plasticizer are abundantly described and thus may be preferably used even in the present invention.

As the other plasticizers, (di)pentaerythritol esters described in Japanese Patent Application Laid-Open No. H11-124445, glycerol esters described in Japanese Patent Application Laid-Open No. H11-246704, diglycerol esters described in Japanese Patent Application Laid-Open No. 2000-63560, citric acid esters described in Japanese Patent Application Laid-Open No. H11-92574, substituted phenylphosphoric acid esters described in Japanese Patent Application Laid-Open No. H11-90946, ester compounds containing an aromatic ring and a cyclohexane ring described in Japanese Patent Application Laid-Open No. 2003-165868 and the like are preferably used.

Further, a polymer plasticizer including a resin component having a molecular weight from 1,000 to 100,000 is also preferably used. Examples thereof include a polyester and/or a polyether described in Japanese Patent Application Laid-Open No. 2002-22956, a polyester ether, a polyester urethane and a polyester described in Japanese Patent Application Laid-Open No. H5-197073, a copolyester ether described in Japanese Patent Application Laid-Open No. H2-292342, an epoxy resin or a novolac resin described in Japanese Patent Application Laid-Open No. 2002-146044 and the like.

Further, as the plasticizer excellent in evaporation resistance, bleed out, low haze and the like, it is preferred to use polyester diols having a hydroxyl group at both terminals, described in, for example, Japanese Patent Application Laid-Open No. 2009-98674. In addition, as the plasticizer excellent in surface smoothness of an optical film or low haze, polyester compounds described in Japanese Patent Application Laid-Open Nos. 2009-155454, 2009-235377, 2009-299014, 2010-031132, 2010-053254 and 2010-242050, or a sugar ester derivative described in WO2009/031464 are also preferred.

These plasticizers may be either alone or in combination of two or more thereof. An amount of the plasticizer added may be 2 parts by mass to 120 parts by mass, and is preferably 2 parts by mass to 70 parts by mass, more preferably 2 parts by mass to 30 parts by mass, and particularly preferably 5 parts by mass to 20 parts by mass, based on 100 parts by mass of the thermoplastic resin. Further, from the viewpoint that generation of disorder at an interface of a dope during the casting is reduced, adhesion with the interface is controlled, or curls are reduced depending on the combination of plasticizers in adjacent layers in a dope for the layer A (dope A), a dope for the layer B (dope B), and (a dope for the layer C (dope C)) used in the manufacturing method of the present invention to be described below, it is preferred that the plasticizer is appropriately selected.

(UV Absorber)

A UV absorber may be further added to the peelable laminated film of the present invention in order to enhance light fastness of the film itself or prevent deterioration in a polarizing plate or an image display member of a liquid crystal display device such as a liquid crystal compound.

As the UV absorber, it is preferred to use a UV absorber which has excellent ability of absorbing ultraviolet light at a wavelength of 370 nm or less in view of preventing deterioration in the liquid crystal and absorbs visible light at a wavelength of 400 nm or more as little as possible in view of good image display property. In particular, the transmittance at a wavelength of 370 nm is preferably 20% or less, more preferably 10% or less, and still more preferably 5% or less. Examples of the UV absorber include an oxybenzophenone-based compound, a benzotriazole-based compound, a salicylic acid ester-based compound, a benzophenone-based compound, a cyanoacrylate-based compound, a nickel complex salt-based compound, a polymer UV absorbing compound containing the aforementioned UV absorbing group and the like, but the UV absorber is not limited thereto. Two or more UV absorbers may be used.

The peelable laminated film of the present invention may contain an additive along with one or two or more thermoplastic resins as a main raw material. Examples of the additive include a fluorine-based surfactant (preferred addition amount is 0.01% by mass to 1% by mass with respect to the thermoplastic resin), a peeling agent (0.0001% by mass to 1% by mass), a deterioration inhibitor (0.0001% by mass to 1% by mass), an optical anisotropy controlling agent (0.01% by mass to 10% by mass), an infrared absorbing material (0.001% by mass to 1% by mass), and the like.

Further, particles composed of trace amounts of organic materials, inorganic materials and mixtures thereof may be dispersed and contained within a range not impairing the effect of the present invention. When the particles are added (as a matting agent) for the purpose of enhancing a conveying property of the peelable laminated film during the film formation, a particle diameter of the particles is preferably 5 nm to 3,000 nm, and an addition amount thereof is preferably 1% by mass or less.

(Polarizer Durability Enhancer)

It is preferred that at least one of the polarizing plate protective films which may be used in the polarizing plate of the present invention has at least one hydrogen donating group capable of forming a hydrogen bond, and further contains an additive (polarizer durability enhancer) having a ratio of the number of aromatic rings/molecular weight from 100 to 300. When the additive is contained, the additive is preferably contained in an amount of preferably 1 part by mass to 20 parts by mass based on 100 parts by mass of a resin (cellulose ester or a resin capable of a solution film-formation different from cellulose ester) included in the film. The additive may be used to improve the polarizer durability in the polarizing plate protective film under high temperature and high humidity. Due to an effect of a hydroxyl group in the additive, it is easy for the additive to be present unevenly at the interface of the polarizer and the polarizing plate protective film under high temperature and high humidity, and the aromatic ring in the additive suppresses boric acid in the polarizer from being diffused into the polarizing plate protective film and exiting out of the polarizing plate.

Examples of the hydrogen-donating group capable of forming a hydrogen bond are described in, for example, literature such as Introduction to Hydrogen Bonding written by Jeffrey, George A. and published by Oxford UP.

The ratio of the number of aromatic rings/molecular weight in the polarizer durability enhancer of the present invention is preferably 100 to 300. The ratio is more preferably 100 to 250, and most preferably 100 to 200.

The polarizer durability may be greatly enhanced under high temperature and high humidity by lowering the ratio of the number of aromatic rings/molecular weight than the lower limit.

(Molecular Weight)

A molecular weight of the polarizer durability enhancer is preferably 200 to 1,000, more preferably 250 to 800 and particularly preferably 280 to 600. It is possible to suppress the loss caused by the volatilization of the polarizer durability enhancer during the film formation of the polarizing plate protective film when the molecular weight is equal to or more than the lower limit in the above-described range, and it is possible to obtain a polarizing plate film having a low haze because the polarizer durability enhancer has good compatibility with cellulose acylate when the molecular weight is equal to or less than the upper limit in the above-described range, and thus the ranges are preferred.

A compound (styrenated phenol) represented by Formula (1) is also preferred as the polarizer durability enhancer of the present invention.

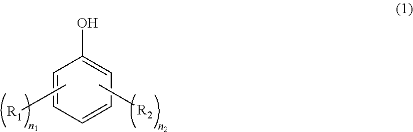

In Formula (1), R¹ represents a hydrogen atom or a substituent and R² represents a substituent represented by the following Formula (1-2); n₁ represents an integer of 0 to 4, and each R¹ may be the same or different when n¹ is 2 or more; and n₂ represents an integer of 1 to 5, and each R² may be the same or different when n₂ is 2 or more.

R₁ represents a hydrogen atom or a substituent. Examples of the substituent are not particularly limited, and include an alkyl group (preferably an alkyl group having 1 to 10 carbon atoms, for example, methyl, ethyl, isopropyl, t-butyl, pentyl, heptyl, 1-ethylpentyl, benzyl, 2-ethoxyethyl, 2-carboxymethyl and the like), an alkenyl group (preferably an alkenyl group having 2 to 20 carbon atoms, for example, vinyl, allyl, oleyl and the like), an alkynyl group (preferably an alkynyl group having 2 to 20 carbon atoms, for example, ethynyl, butadiynyl, phenylethynyl and the like), a cycloalkyl group (preferably a cycloalkyl group having 3 to 20 carbon atoms, for example, cyclopropyl, cyclopentyl, cyclohexyl, 4-methylcyclohexyl and the like), an aryl group (preferably an aryl group having 6 to 26 carbon atoms, for example, phenyl, 1-naphthyl, 4-methoxyphenyl, 2-chlorophenyl, 3-methylphenyl and the like), a hetero ring group (preferably a hetero ring group having 2 to 20 carbon atoms, for example, 2-pyridyl, 4-pyridyl, 2-imidazolyl, 2-benzimidazolyl, 2-thiazolyl, 2-oxazolyl and the like), an alkoxy group (preferably an alkoxy group having 1 to 20 carbon atoms, for example, methoxy, ethoxy, isopropyloxy, benzyloxy and the like), an aryloxy group (preferably an aryloxy group having 6 to 26 carbon atoms, for example, phenoxy, 1-naphthyloxy, 3-methylphenoxy, 4-methoxyphenoxy and the like), an alkoxycarbonyl group (preferably an alkoxycarbonyl group having 2 to 20 carbon atoms, for example, ethoxycarbonyl, 2-ethylhexyloxycarbonxyl and the like), an amino group (preferably an amino group having 0 to 20 carbon atoms, for example, amino, N,N-dimethylamino, N,N-diethylamino, N-ethylamino, anilino and the like), a sulfonamide group (preferably a sulfonamide group having 0 to 20 carbon atoms, for example, N,N-dimethyl sulfonamide, N-phenyl sulfonamide and the like), an acyloxy group (preferably an acyloxy group having 1 to 20 carbon atoms, for example, acetyloxy, benzoyloxy and the like), a carbamoyl group (preferably a carbamoyl group having 1 to 20 carbon atoms, for example, N,N-dimethylcarbamoyl, N-phenylcarbamoyl and the like), an acylamino group (preferably an acylamino group having 1 to 20 carbon atoms, for example, acetylamino, benzoylamino and the like), a cyano group or a halogen atom (for example, a fluorine atom, a chlorine atom, a bromine atom, an iodine atom and the like), and a hydroxyl group. R¹ is preferably a hydrogen atom, an alkyl group having 1 to 20 carbon atoms and a hydroxyl group, and more preferably a hydrogen atom, a hydroxyl group and a methyl group. In addition, R¹ may have one or more of the substituents in a substituent.

n₁ represents an integer of 0 to 4, and is preferably 2 to 4.

n₂ represents an integer of 1 to 5, and is preferably 1 to 3. Further, it is preferred that n₁ and n₂ satisfy the relationship n₁+n₂=5.

R² represents a substituent represented by the following Formula (1-2).

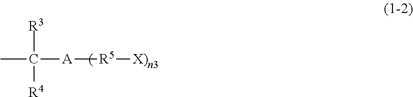

In Formula (1-2), A represents a substituted or unsubstituted aromatic ring; R³ and R⁴ each independently represent a hydrogen atom, an alkyl group having 1 to 5 carbon atoms, or a substituent represented by Formula (1-3); R⁵ represents a single bond or an alkylene group having 1 to 5 carbon atoms; X represents a substituted or unsubstituted aromatic ring; and n3 represents an integer of 0 to 10, and each of R⁵'s and X's may be the same or different when n3 is 2 or more. A represents a substituted or unsubstituted aromatic ring. The aromatic ring may be a heterocyclic ring including a hetero atom such as a nitrogen atom, an oxygen atom and a sulfur atom. Examples of the A include a benzene ring, an indene ring, a naphthalene ring, a fluorene ring, a phenanthrene ring, an anthracene ring, a biphenyl ring, a pyrene ring, a pyran ring, a dioxane ring, a dithiane ring, a thiin ring, a pyridine ring, a piperidine ring, an oxazine ring, a morpholine ring, a thiazine ring, a pyridazine ring, a pyrimidine ring, a pyrazine ring, a piperazine ring, a triazine ring and the like. Further, the ring may be condensed with another 6- or 5-membered ring. A is preferably a benzene ring. Examples of a substituent which A may have include a halogen atom (for example, a fluorine atom, a chlorine atom, a bromine atom, an iodine atom and the like), an alkyl group, a hydroxyl group and the like.

R³ and R⁴ each independently represent a hydrogen atom or an alkyl group having 1 to 5 carbon atoms and a substituent represented by the following Formula (1-3). R³ and R⁴ are preferably a hydrogen atom, an alkyl group having 1 to 3 carbon atoms and the substituent represented by Formula (1-3), and more preferably a hydrogen atom, a methyl group and the substituent represented by Formula (1-3).

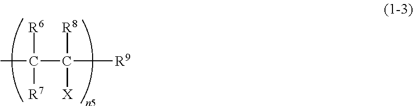

In Formula (1-3), X represents a substituted or unsubstituted aromatic ring; R⁶, R⁷, R⁸ and R⁹ each independently represent a hydrogen atom or an alkyl group having 1 to 5 carbon atoms; and n5 represents an integer of 1 to 11, and each of R⁶'s, R⁷'s, R⁸'s and R⁹'s and X's may be the same or different when n5 is 2 or more.

X in Formula (1-3) has the same meaning as X in Formula (1-2), and preferred ranges thereof are also the same.

R⁶, R⁷, R⁸ and R⁹ each independently represent a hydrogen atom or an alkyl group having 1 to 5 carbon atoms. R³ and R⁴ are preferably a hydrogen atom and an alkyl group having 1 to 3 carbon atoms, and more preferably a hydrogen atom and a methyl group.

n5 represents an integer of 1 to 11, preferably 1 to 9, and more preferably 1 to 7.

Formula (1-3) is preferably represented by the following Formula (1-3′).

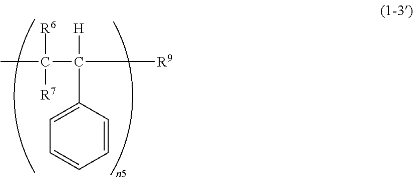

The definition of each symbol in Formula (1-3′) has the same meaning as the definition in Formula (1-3), and preferred ranges thereof are also the same.

Formula (1-3) is preferably represented by the following Formula (1-3″).

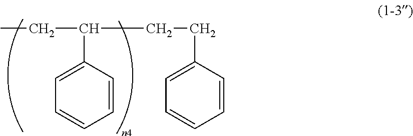

In Formula (3″), n4 represents an integer of 0 to 10.

n4 represents an integer of 0 to 10, preferably 0 to 8, and more preferably 0 to 6.

In Formula (1-2), R⁵ represents a single bond or an alkylene group having 1 to 5 carbon atoms, and may have a substituent. R⁵ is preferably an alkylene group having 1 to 4 carbon atoms and more preferably an alkylene group having 1 to 3 carbon atoms. Examples of a substituent that R⁵ may have include an alkyl group having 1 to 5 carbon atoms (for example, methyl, ethyl, isopropyl and t-butyl), a halogen atom (for example, a fluorine atom, a chlorine atom, a bromine atom, an iodine atom and the like), a hydroxyl group and the like.

X represents a substituted or unsubstituted aromatic ring. The aromatic ring may be a heterocyclic ring including a hetero atom such as a nitrogen atom, an oxygen atom and a sulfur atom. Examples of the X include a benzene ring, an indene ring, a naphthalene ring, a fluorene ring, a phenanthrene ring, an anthracene ring, a biphenyl ring, a pyrene ring, a pyran ring, a dioxane ring, a dithiane ring, a thiin ring, a pyridine ring, a piperidine ring, an oxazine ring, a morpholine ring, a thiazine ring, a pyridazine ring, a pyrimidine ring, a pyrazine ring, a piperazine ring, a triazine ring and the like. Further, the ring may be condensed with another 6- or 5-membered ring. X is preferably a benzene ring. A substituent that X may have is the same as the substituent exemplified as the substituent of A.

n3 represents an integer of 0 to 10, preferably 0 to 2 and more preferably 0 to 1.

Formula (1-2) is preferably represented by the following Formula (2′).

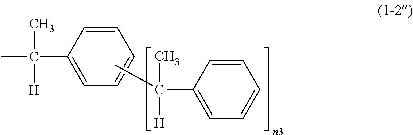

In Formula (1-2′), R³ represents a hydrogen atom, an alkyl group having 1 to 5 carbon atoms or the substituent represented by Formula (1-3); R⁵ represents a single bond or an alkylene group having 1 to 5 carbon atoms; X represents a substituted or unsubstituted aromatic ring; and n3 represents an integer of 0 to 5, and each of R⁵'sand X's may be the same or different when n3 is 2 or more.

A preferred range of each symbol in Formula (1-2′) is the same as that of each symbol in Formula (1-2).

Formula (1-2) is preferably represented by the following Formula (1-2″).

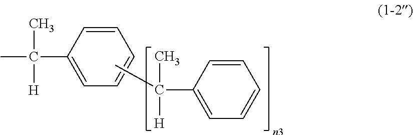

In Formula (1-2″), n3 represents an integer of 0 to 5.

The preferred range of n3 in Formula (1-2″) is the same as that of n3 in Formula (1-2).

The compound represented by Formula (1) is preferably an aspect in which R¹ is a hydrogen atom or an alkyl group having 1 to 5 carbon atoms. R² is represented by Formula (1-2″), n1 represents an integer of 2 to 4, n2 represents an integer of 1 to 3, and n3 represents an integer of 0 to 2.

Hereinafter, specific examples of the compound represented by Formula (1) will be described, but the present invention is not limited to the following specific examples.

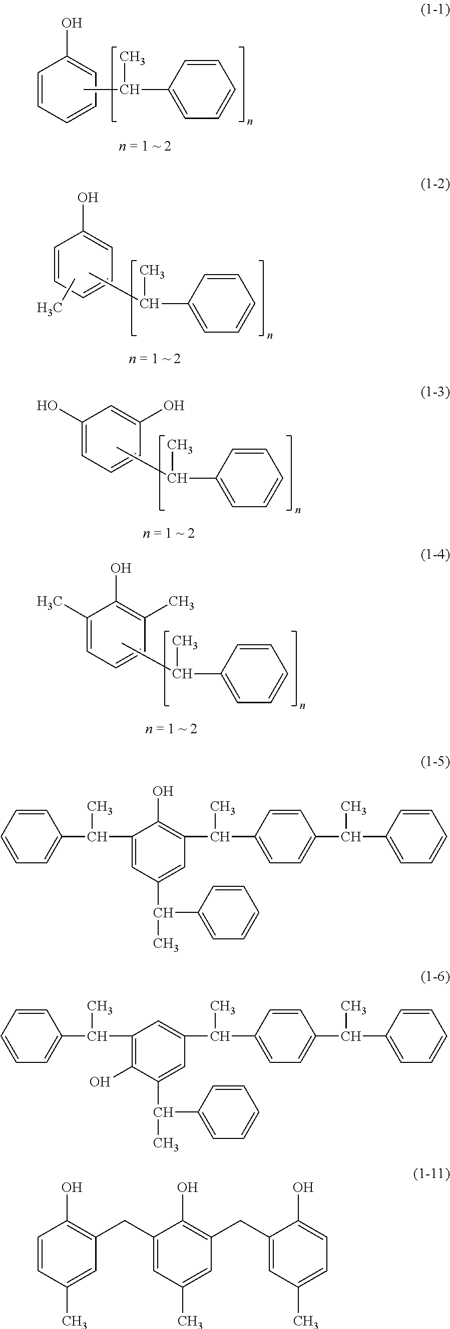

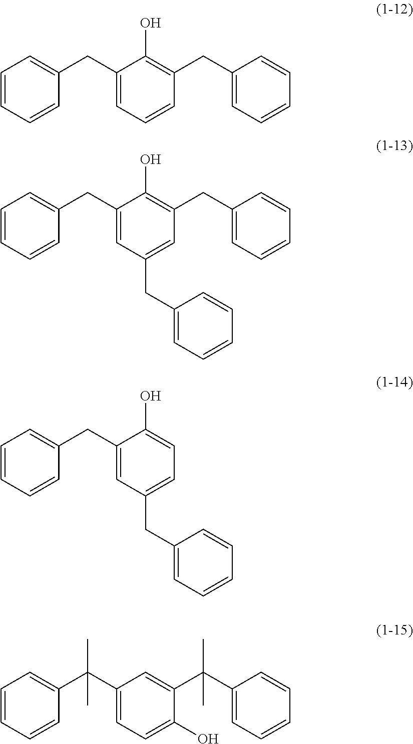

Further, in order to enable hydrogen bonding to be achieved in that there are a lot of styrenated phenols, which are different in the number of hydroxyl groups, a mixture containing at least two compounds represented by different two or more of Formula (1) may be used. An example thereof includes a mixture of a styrenated phenol having 1 to 3 moles of styrene alkylated for phenol, a styrenated phenol with styrene further alkylated on a phenyl moiety of an alkylated styrene and a styrenated phenol with an oligomer which is approximately a dimer to tetramer alkylated to phenol.

The compound represented by Formula (1) may be generally synthesized by adding one equivalent or more of styrenes to one equivalent of phenols in the presence of an acid catalyst, and a commercially available product may be used. In addition, a mixture obtained by the synthetic method may be used as it is.

<Organic Acid>

The film of the present invention may be used as a protective film of a polarizing plate. In this case, it is preferred that a resin and an organic acid having an acid dissociation constant from 2 to 7 in a mixed solvent having a volume ratio of tetrahydrofuran/water=6/4 at 25° C. are contained in amounts from 0.1 by mass to 20 parts by mass based on 100) parts by mass of the resin. The organic acid may be used to improve the polarizer durability under high temperature and high humidity without degrading the polarizer durability in the polarizing plate protective film under high temperature and low humidity.

<Organic Acid>

(Solubility)

The organic acid included in the film of the present invention has a solubility of 0.1% by mass or less in water at 25° C. The solubility of the organic acid in water at 25° C. is preferably 0.06% by mass or less, and more preferably 0.03% by mass or less.

As a method of measuring the solubility in the present invention, a method described in Lectures of Experimental Chemistry, 4th Edition, pp. 153 to 156, published by Manruzen Co., Ltd. is adopted.

The organic acid included in the film of the present invention is an organic acid having an acid dissociation constant from 2 to 7 in a mixed solvent having a volume ratio of THF/water=6/4 at 25° C. The acid dissociation constant of the organic acid in the mixed solvent having a volume ratio of THF/water 6/4 is preferably 2.5 to 7, more preferably 2.5 to 6.5, and particularly preferably 3 to 5.

As a method of measuring the acid dissociation constant in the present invention, an alkali titration method described in Lectures of Experimental Chemistry, 2nd Edition, pp. 215 to 217, published by Maruzen Co., Ltd. is adopted.

(Molecular Weight)

A molecular weight of the organic acid included in the film of the present invention is preferably 200 to 1,000, more preferably 250 to 800 and particularly preferably 280 to 500. When the molecular weight is equal to or more than the lower limit of the above-described range, the polarizer durability under high temperature and low humidity is improved, and when the molecular weight is equal to or less than the upper limit of the above-described range, the polarizer durability under high temperature and high humidity is improved, and thus the ranges are preferred.

(Structure)

The organic acid included in the film of the present invention includes preferably an aromatic ring structure, preferably an aryl group having 6 to 12 carbon atoms, and particularly preferably a phenyl group. The aromatic ring structure of the organic acid may form a condensed ring with the other rings. The aromatic ring structure of the organic acid may have a substituent, and the substituent is not particularly limited as long as the substituent does not deviate from the spirit of the present invention, but is preferably a halogen atom or an alkyl group, more preferably a halogen atom or an alkyl group having 1 to 6 carbon atoms, and particularly preferably a chlorine atom or a methyl group.

It is preferred that the organic acid is represented by the following Formula (3).

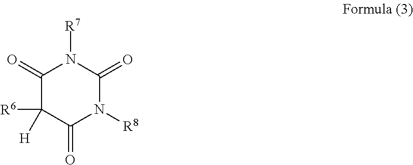

In Formula (3), R⁶ represents an aryl group and R⁷ and R⁸ each independently represent a hydrogen atom, an alkyl group or an aryl group. R⁶ and R⁷ each may have a substituent.

R⁶ is preferably an aryl group having 6 to 18 carbon atoms, more preferably an aryl group having 6 to 12 carbon atoms and particularly preferably a phenyl group.

R⁷ and R⁸ are each independently preferably a hydrogen atom, an alkyl group having 1 to 12 carbon atoms (also including a cycloalkyl group) or an aryl group having 6 to 12 carbon atoms, more preferably a hydrogen atom, an alkyl group having 1 to 6 carbon atoms (also including a cycloalkyl group) or a phenyl group, and particularly preferably a hydrogen atom, a methyl group, an ethyl group, a cyclohexyl group or a phenyl group.

A substituent that R⁶ may have is not particularly limited as long as the substituent does not deviate from the spirit of the present invention, but is preferably a halogen atom or an alkyl group, more preferably a halogen atom or an alkyl group having 1 to 6 carbon atoms, and particularly preferably a chlorine atom or a methyl group.

A substituent that R⁷ may have is not particularly limited as long as the substituent does not deviate from the spirit of the present invention, but the substituent is preferably an aryl group having 6 to 12 carbon atoms, and more preferably a phenyl group.

Hereinafter, specific examples of the organic acid represented by Formula (3) will be exemplified, but the present invention is not limited thereto. Further, organic acid (3-3) corresponds to an additive U2 used in Examples.

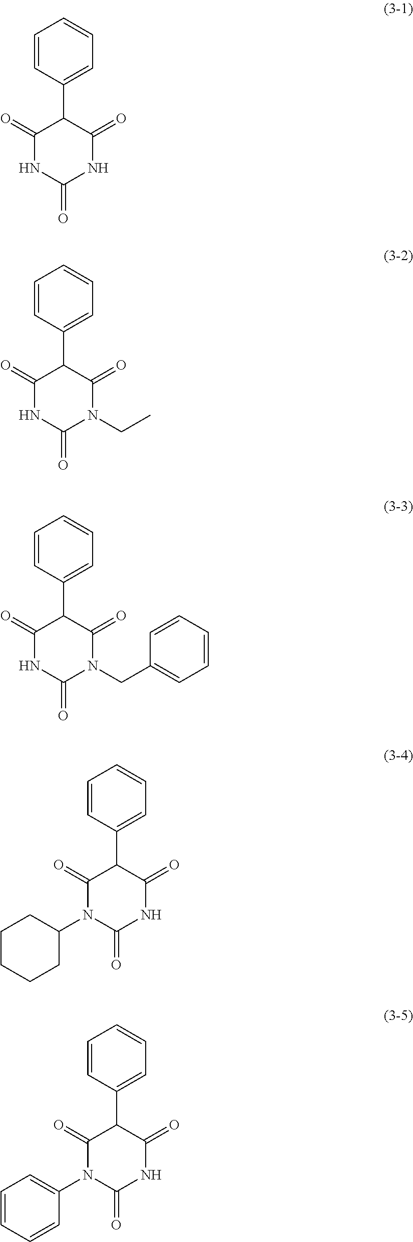 [SMILES: O=C1NC(=O)C(c2ccccc2)C(=O)N1 ; CCN1C(=O)NC(=O)C(c2ccccc2)C1=O ; O=C1NC(=O)N(Cc2ccccc2)C(=O)C1c1ccccc1 ; O=C1NC(=O)N(C2CCCCC2)C(=O)C1c1ccccc1 ; O=C1NC(=O)N(c2ccccc2)C(=O)C1c1ccccc1]

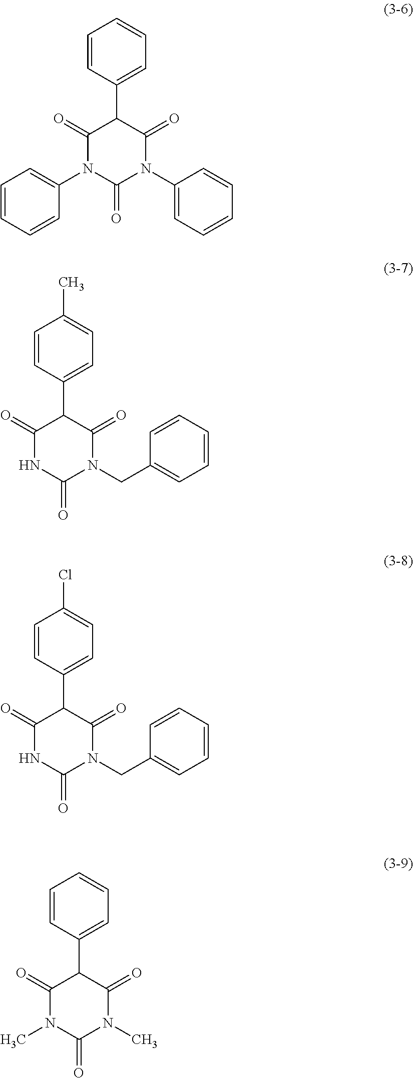 [SMILES: O=C1C(c2ccccc2)C(=O)N(c2ccccc2)C(=O)N1c1ccccc1 ; Cc1ccc(C2C(=O)NC(=O)N(Cc3ccccc3)C2=O)cc1 ; O=C1NC(=O)N(Cc2ccccc2)C(=O)C1c1ccc(Cl)cc1 ; CN1C(=O)C(c2ccccc2)C(=O)N(C)C1=O]

(Method of Obtaining Organic Acid)

The organic acid used in the present invention may be commercially available, and may be synthesized by publicly known methods.

(Content of Organic Acid)

The organic acid is preferably 1 to 20% by mass with respect to the resin used in the film. When the amount is 1% by mass or more, it is easy to obtain the polarizer durability improvement effect, and when the amount is 20% by mass or less, it is difficult to generate bleed-out or ooze out during the film formation of the polarizing plate protective film. The content of the organic acid is more preferably 1% by mass to 15% by mass and particularly preferably 1% by mass to 10% by mass.

(Acid dissociation constant of organic acid)

In the organic acid included in the polarizing plate protective film used in the polarizing plate of the present invention, the acid dissociation constant in a mixed solvent having a volume ratio of tetrahydrofuran/water=6/4 at 25° C. is preferably 2 to 7, more preferably 3 to 6, and still more preferably 3 to 5.

As a method of measuring the acid dissociation constant in the present invention, an alkali titration method described in Lectures of Experimental Chemistry, 2nd Edition, pp. 215 to 217, published by Maruzen Co., Ltd. is adopted.

(Particle)

Particles may be added in order to impart unevenness to the surface of the film or impart light scatterability to the inside of the film, and in that case, a particle diameter of the particles is preferably 1 μm to 20 μm, and the amount of the particle added is preferably 2% by mass to 30% by mass. A difference in a refractive index between the particles and a polymer film of the invention is preferably 0 to 0.5, and for example, examples of particles of an inorganic material include particles of silicon oxide, aluminum oxide, barium sulfate and the like. Examples of the particles of an organic material include acrylic resins, divinylbenzene-based resins, benzoguanamine-based resins, styrene-based resins, melamine-based resins, acryl-styrene-based resins, polycarbonate-based resins, polyethylene-based resins, polyvinyl chloride-based resins, and the like.

<Lamination of Additional Layer onto Film>

In the peelable laminated film of the present invention and a film obtained by being peeled off from the peelable laminated film, another coating layer may be further formed on at least one surface of the laminate.

As the coating layer, for example, a curable resin layer having a thickness of 0.1 μm to 15 μm may be formed. Further, in the optical film of the present invention, an optical functional layer such as an antistatic layer, a high-refractive index layer and a low-refractive index layer may also be formed on the curable resin layer. Further, the curable resin layer may also serve as an antistatic layer or a high refractive index layer.

The curable resin layer is preferably formed by a crosslinking reaction or a polymerization reaction of an ionized radiation curable compound. For example, the curable resin layer may be formed, for example, by coating a coating composition including ionized radiation curable polyfunctional monomers or polyfunctional oligomers on a light-transmitting substrate, and subjecting the polyfunctional monomers or the polyfunctional oligomers to a crosslinking reaction or a polymerization reaction.

The functional group of the ionized radiation curable polyfunctional monomers or the polyfunctional oligomers is preferably photopolymerizable, electron-polymerizable or radiation-polymerizable, and among them, a photopolymerizable functional group is preferred. Examples of the photopolymerizable functional group include an unsaturated polymerizable functional group such as a (meth)acryloyl group, a vinyl group, a styryl group, and an allyl group, and among them, a (meth)acryloyl group is preferred.

Further, in the curable resin layer, it is possible to use any publicly known additive such as a leveling agent, an antifouling agent, an antistatic agent, a refractive index-controlling inorganic filler, scattering particles, and a thixotropic agent.

Further, strength of the film formed with the curable resin layer is preferably H or more in a pencil hardness test, and more preferably 2H or more. In addition, it is also possible to form a phase difference layer constituted by orienting and curing a crystalline polymerizable compound having a bar shape or a discotic shape.

[Method for Manufacturing Peelable laminated Film of Present Invention]

The method for manufacturing a peelable laminated film according to the present invention (hereinafter, also referred to as the manufacturing method of the present invention) is characterized by simultaneously or sequentially casting and laminating a dope A for forming a layer A, which contains cellulose ester and a solvent (preferably an organic solvent) and a dope B for forming a layer B, which contains a resin capable of a solution film-formation different from the cellulose ester of the dope A and a solvent (preferably an organic solvent) on a casting support (casting substrate), peeling off a laminate of the dope A and the dope B from the casting support, and drying the laminate.

Hereinafter, preferred aspects of the manufacturing method of the present invention will be described.

(Film-Formation Method of Peelable Laminated Film)

Examples of a film-formation method of the peelable laminated film of the present invention include a publicly known method for molding a laminated film such as a solution cast method (solution casting method), a melt extrusion method, a calendaring method and a compression molding method. The manufacturing method of the present invention is characterized by manufacturing the peelable laminated film of the present invention with good productivity by using a solution cast method (solution casting method) among them.

<Preparation of Dope>

A dissolution method for preparing a solution (dope) of the thermoplastic resin used in the manufacture of the peelable laminated film of the present invention is performed by a room-temperature dissolution method, a cooling dissolution method or a high-temperature dissolution method or a combination thereof. With respect to the methods, the preparation method of a cellulose acylate solution is described in, for example, Japanese Patent Application Laid-Open Nos. H5-163301, S61-106628, S58-127737, H9-95544, H10-95854, H10-45950, 2000-53784, H11-322946, H11-322947, H2-276830, 2000-273239, 1H11-71463, H04-259511, 2000-273184, H11-323017, H11-302388 and the like. The techniques for the method of dissolving the cellulose acylate in an organic solvent may be appropriately applied even to the cellulose ester of the present invention and the other thermoplastic resins. As for the details thereof, and particularly, the non-chlorine type solvent system, the dope is prepared by the method described in detail in the Open Technical Report No. 2001-1745, pp. 22 to 25. Further, the dope solution of thermoplastic resin is usually subjected to solution concentration and filtration, and is described in detail in the Open Technical Report No. 2001-1745, page 25. In addition, in the case of dissolution at high temperature, the temperature is in most cases not lower than the boiling temperature of the organic solvent used and in that case, the system is used in a pressurized state.

(Organic Solvent)

In the manufacturing method of the present invention, an organic solvent, in which a dope is formed by each dissolving the cellulose ester and a resin capable of a solution film-formation different from the cellulose ester of the dope A, will be described. Examples of the organic solvent used include organic solvents publicly known in the related art and, for example, a solvent having a dissolution parameter ranging from 17 to 22 is preferred. The dissolution parameter refers to that described in, for example, J. Brandrup, E. H, et al., “Polymer Handbook (4th Edition)”, VII/671 to VII/714. Examples thereof include a chloride of lower aliphatic hydrocarbon, a lower aliphatic alcohol, a ketone having 3 to 12 carbon atoms, an ester having 3 to 12 carbon atoms, an ether having 3 to 12 carbon atoms, aliphatic hydrocarbons having 5 to 8 carbon atoms, aromatic hydrocarbons having 6 to 12 carbon atoms, and fluoroalcohols (for example, compounds described in paragraph No. [0020] of Japanese Patent Application Laid-Open No. H8-143709 and paragraph No. [0037] of Japanese Patent Application Laid-Open No. H11-60807) and the like.

The solvent used in the present invention may be used either alone or in combination thereof, but it is preferred to use a mixture of a good solvent and a poor solvent in order to impart surface shape stability, and more preferably, in a mixture ratio of the good solvent and the poor solvent, the contents of the good solvent and the poor solvent are 60% by mass to 99% by mass and 40% by mass to 1% by mass, respectively. The good solvent in the present invention refers to a solvent which dissolves the resin used alone, and the poor solvent refers to a solvent which does not swell or dissolve the resin used alone. Examples of the good solvent used in the present invention include organic halogen compounds such as methylene chloride and dioxolanes. In addition, as the poor solvent used in the present invention, for example, methanol, ethanol, n-butanol, cyclohexane and the like are preferably used.

A proportion of an alcohol in the organic solvent contained in the dope A and the dope B is preferably 10% by mass to 50% by mass of the entire organic solvent because the time required for drying on a casting support (casting substrate) after the film-formation is shortened, and thus the film may be rapidly peeled off and dried, and more preferably 15% by mass to 30% by mass.

(Solid Concentration of Dope)

The materials for forming the peelable laminated film of the present invention are preferably dissolved in an organic solvent so as to yield a solid concentration (sum of components that are solids after being dried) from 10% by mass to 60% by mass, and more preferably 10% by mass to 50% by mass. When the cellulose acylate-based resin is used as a main component, the cellulose acylate-based resin is dissolved at a solid concentration of preferably 10% by mass to 30% by mass, more preferably 15% by mass to 25% by mass, and most preferably 18% by mass to 20% by mass. However, depending on the use, the solid concentration of the dope A is preferably more than 20% by mass and equal to or less than 22% by mass in some cases because the content of an organic solvent may be reduced, the time required for drying may be shortened, and the like. As a preparation method at the solid concentrations, a solution may be prepared such that the solid concentration is adjusted to be a predetermined value at the stage of dissolution, and also, a low-concentration solution (for example, 9% by mass to 14% by mass) may be prepared in advance, and then may be adjusted to a predetermined high-concentration solution in a concentration process. Further, a high-concentration solution may be prepared in advance, and then various additives may be added thereto to prepare a solution a predetermined low-concentration solution.

From the viewpoint of achieving a support releasing property, an interfacial adhesion property, and low curl, it is preferred that a composition of the thermoplastic resin in the dopes A and B satisfies the following conditions. A proportion of a cellulose ester in the thermoplastic resin of the dope A is preferably 50% by mass to 100% by mass, more preferably 70% by mass to 100% by mass, and most preferably 80% by mass to 100% by mass. A proportion of a (meth)acrylic resin in the thermoplastic resin of the dope B is preferably 30% by mass to 100% by mass, more preferably 50% by mass to 100% by mass, and most preferably 70% by mass to 100% by mass.

Meanwhile, in order to obtain a peelable laminated film having a good surface shape by means of film formation by co-casting, a difference in the solid concentration between the dope B and the dope A is preferably within 10% by mass, and more preferably within 5% by mass.

In particular, in the dope B, the solid concentration is preferably 16% by mass to 30% by mass, and a difference in the solid concentration between the dope B and the dope A is preferably within 10% by mass.

<Complex Viscosity of Dope>

In the manufacturing method of the present invention, it is preferred that a complex viscosity η_{A} of the dope A and the complex viscosity η_{B} of the dope B at 25° C. are controlled so as to satisfy the relationship of following Formula (III).

η_{A}≦η_{B} (Formula III)

In the manufacturing method of the present invention, it is preferred that among them, both the complex viscosities of the dope A and the dope B are 10 to 80 Pa·s or less and the complex viscosity of the dope B is larger than that of the dope A from the viewpoint of improving the surface shape of the peelable laminated film after the film-formation.

In the preparation method of the present invention, both the complex viscosities of the dope A and the dope B are 10 to 80 Pa·s or less. By setting the complex viscosity to this range, the solution casting suitability tends to be enhanced more, which is preferred. Here, the complex viscosity of the doping in the present invention refers to a viscosity measured by a solution shear rheometer.

When the complex viscosity is within the range, an effect of suppressing the peelable laminated film from being whitened is further increased. The complex viscosity is still more preferably 20 Pa·s to 80 Pa·s, and particularly preferably 25 Pa·s to 70 Pa·s. The viscosity is measured in the following manner. 1 mL of a sample solution (1 mL) is measured using Steel Cone with a diameter of 4 cm/2° in a rheometer (CIS 500) (both manufactured by TA Instruments, Inc.).

The sample solution is warmed in advance until the solution temperature becomes constant at the measurement start temperature, and then the measurement is started. The temperature at that time is not particularly limited as long as the temperature is a temperature during the casting, but the temperature is preferably −5° C. to 70° C., and more preferably −5° C. to 35° C. As described above, in the present invention, a value at 25° C. is adopted.

<Co-Casting Process>

(Casting)

The manufacturing method of the present invention includes a process of performing casting by laminating on a casting substrate by a co-casting method of simultaneously casting a dope A containing cellulose ester and an organic solvent and a dope B containing a resin capable of a solution film-formation different from cellulose ester of the dope A and an organic solvent or a subsequent casting method of subsequently casting the dope A and the dope B. As a method of forming a laminate, a co-casting method by which casting may simultaneously performed is preferred, and the method will be described hereinafter using examples of the co-casting.

The number of layers in lamination is not particularly limited, but since a handling property of the laminate is changed depending on a thickness of each layer or the whole laminate and interlayer adhesion, the number of layers which is capable of casting may be selected by a layer configuration. In this case, when the total film thickness of the peelable laminated film is 20 μm to 200 μm, a technology of an already known solution casting method may be used, which is preferred.

Further, a lamination form is at least a laminate of the dope A and the dope B, but may be an alternating layer structure of a plurality of layers of the dope A and/or the dope B, and when the alternating layer structure is adopted, the thickness of each layer A and each layer B may be changed, and it may also be possible to obtain a peelable laminated film having different physical properties and the like by changing a material composition ratio and the like.

In addition, it is also possible to form a laminate composed of a variety of layers using a variety of materials such as a dope C containing a resin organic solvent capable of a solution film-formation different from the resin used in the dope A and the dope B, if necessary.

In the manufacturing method of the present invention, a three or more layer laminate may be obtained by laminating any one layer or more of the dope A, the dope B and the dope C different from the dope A and the dope B on the laminate of the dope A and the dope B, and the laminate including the layer A and the layer B is a three or more-layer laminate including at least one of the layer A and the layer B in plural or further including a layer C different from the layer A and the layer B.

Further, it is preferred that the casting thickness of the dope A is controlled such that a dry thickness of the dope A is from 5 μm to 60 μm. The casting method for having the thickness is not particularly limited, but publicly known methods may be used. A more preferred range of the dry thickness is the same as a preferred thickness of the layer A of the optical film of the present invention.

A peelable laminated film may be formed by casting the dope on a casting support, and evaporating the solvent. Here, the casting support is not particularly limited, but is preferably a drum or a band. It is preferred that the surface of the casting support is finished to be in a specular state. Casting and drying methods in the solvent cast method are described in U.S. Pat. Nos. 2,336,310, 2,367,603, 2,492,078, 2,492,977, 2,492,978, 2,607,704, 2,739,069, and 2739070, and British Patent Nos. 640731 and 736892, and Japanese Patent Publication Nos. S45-4554 and S49-5614 and Japanese Patent Application Laid-Open Nos. S60-176834, S60-203430, and S62-115035.

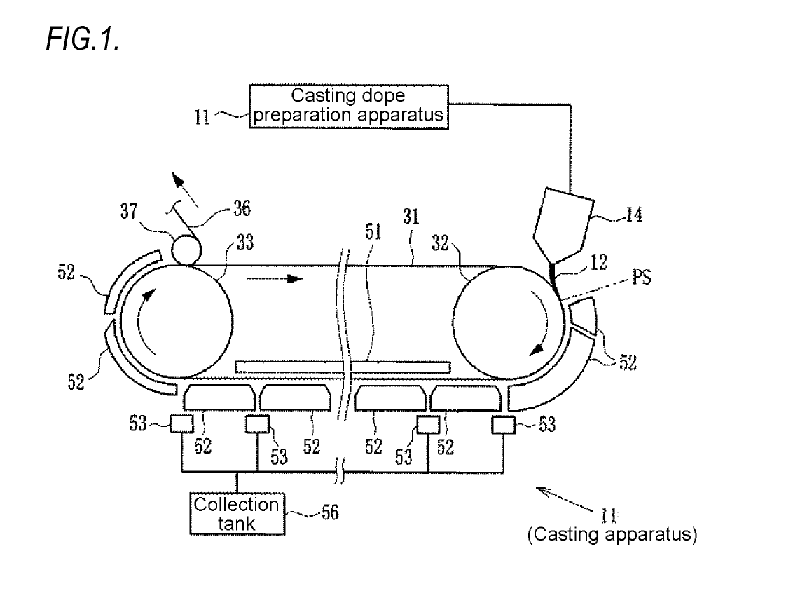

FIG. 1 is a schematic view illustrating a main part of a casting apparatus having a band, and is a plan view from the side. A casting apparatus 11 is composed of a casting die 14, first and second backup rollers 32 and 33, a band 31, a peel roller 37, a temperature regulating plate 51, a plurality of condensing plates 52, a plurality of liquid receivers 53, a collection tank 56 and a liquid feed pipe. Further, three kinds of dopes are each prepared as a casting dope 12, and with these dopes, a casting film may also be manufactured into a three-layer structure by a casting manipulation at one time. PS indicates a casting start position. 36 indicates a peelable laminated film.

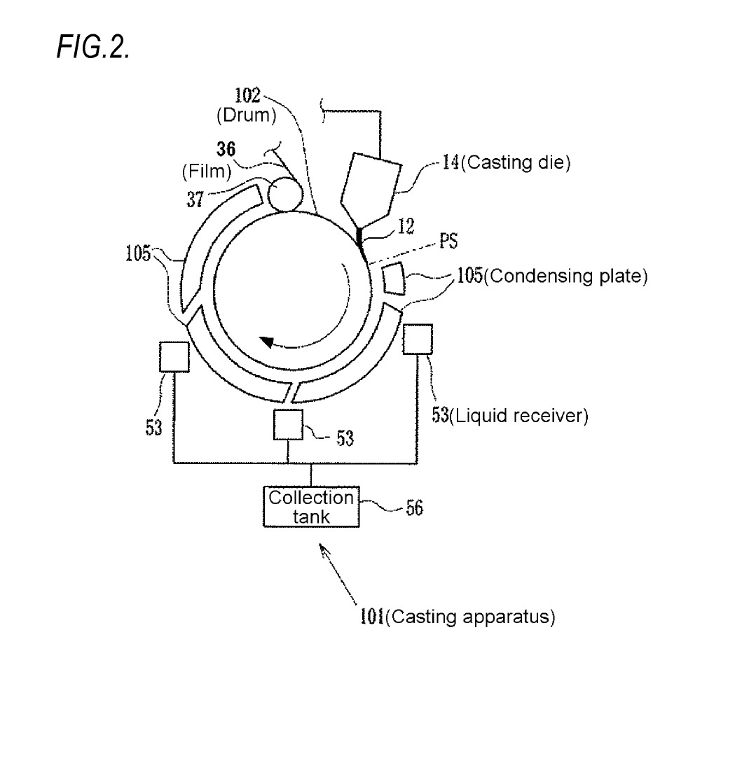

FIG. 2 is a view illustrating a casting apparatus including a drum. FIG. 2 is a schematic view illustrating a main part of the casting apparatus 101, and is a plan view from the side. Further, the explanation will be omitted by designating the same reference numerals to the devices and members which are the same as those as described above in FIG. 1. In FIG. 2, a drum 102 is used instead of the band in FIG. 2. The casting dope 12 from the casting die 14 is cast slightly below an uppermost portion of the drum 102 such that the casting film formed on the drum 102 is directed downward from the casting start position PS. Even in this case, it is preferred that the casting start position PS is determined such that a tangent in the casting start position PS on the drum 102 coincides with a tangent in a casting curve from the casting die 14 as much as possible.

The drum 102 has a temperature adjusting function. On an outer side of the casting film, a plurality of condensing plates 105 is provided, and the solvent enters the external liquid receiver 53 through the slope of gaps between the condensing plates 105, and then is collected in the collection tank 56. The casting film travelling on the drum 102 is peeled off as a peelable laminated film 36 by the peel roller 37 and sent to a drying apparatus for the next process. Accordingly, the solvent may be collected at a high yield by uniformly drying the casting film while preventing dripping. However, even when a travelling direction of the casting film is upward from the casting start position PS by reversing a rotation direction of the drum 102, an effect of uniformly drying the casting film and uniformizing the thickness of the peelable laminated film 36 is obtained.

It is preferred that the dope is cast on a support having a surface temperature of 5° C. or less. The surface temperature of the casting substrate (support) is preferably −30° C. to 5° C., and more preferably −10° C. to 2° C.

It is preferred to blow-dry the casting substrate for 2 seconds or more after the casting is performed. The obtained peelable laminated film may be peeled off from the support and may be dried with high-temperature air while changing the sequential temperature from 100° C. to 160° C., thereby evaporating a residual solvent. The aforementioned method is described in Japanese Patent Application Publication No. H5-17844. According to the method, it is possible to shorten the time from casting to peeling-off. In order to carry out this method, the dope needs to gelate at the surface temperature of the support during the casting.

In the present invention, a film is formed by casting the two or more of the dopes on a support as a casting substrate. The manufacturing method of the peelable laminated film of the present invention is not particularly limited except for the above-described matters, and a publicly known co-casting method may be used. For example, the peelable laminated film may be manufactured by casting and laminating each doping solutions from a plurality of casting apertures formed at intervals in a progressing direction of a metal support, and methods described in Japanese Patent Application Laid-Open Nos. S61-158414, 111-122419, and H11-198285 may be applied. Further, a doping solution from two casting apertures may be cast to form a peelable laminated film, and for example, the casting may be performed by methods described in Japanese Patent Publication No. S60-27562, Japanese Patent Application Laid-Open Nos. S61-94724. S61-947245, S61-104813, S61-158413, and H6-134933.

(Drying Process)

The manufacturing method of the present invention includes a process of removing the organic solvent (process of drying the laminate of the dope A and the dope B, which is peeled off from the casting support).

A method of drying a web, which is dried on a drum or a band and peeled off, will be described. A web, which is peeled off at a peeling position immediately before a drum or a belt makes one complete revolution, is conveyed by a conveying method which allows the web to alternately pass through a group of rolls disposed in a zigzag pattern, or by a method which allows the web to be conveyed in a non-contact way by gripping both ends of the peeled web with a clip and the like, and the like. Drying is performed by a method of blow-drying both sides of the web (peelable laminated film) being conveyed at a predetermined temperature or by a method of using a heating means such as a microwave oven. Since rapid drying may damage the surface smoothness of a peelable laminated film to be formed, it is preferred that the film is dried at a temperature where bubbles are not produced from the solvent at an early stage of drying, and is dried at a high temperature after the drying is progressed. In the drying process after peeling-off from the support, the peelable laminated film intends to be shrunk in a length direction or a width direction by evaporation of the solvent. The shrinkage increases as drying is performed at higher temperatures. It is preferred that the surface smoothness of the manufactured peelable laminated film is improved when the film is dried while the shrinkage is suppressed as much as possible. In this regard, as described in, for example, Japanese Patent Application Laid-Open No. S62-46625, a method (tenter type) of performing a whole drying process or a part thereof while maintaining both ends of the web width in a width direction by means of a clip or a pin is preferred. In the drying process, a drying temperature is preferably 100° C. to 145° C. A drying temperature, a drying air flow and a drying time vary depending on solvents to be used, but may be appropriately selected according to the kinds and combinations of solvents to be used. In the present invention, it is preferred that the dope with which a plurality of layers has been cast is dried, and then peeled-off from the support, and further, the web is dried by the drying method.

In the present invention, the time for which the dope is cast on the casting substrate and peeled off, that is, a time for which the dope is conveyed on the casting substrate is not particularly limited, but is preferably within 180 seconds, and more preferably within 60 seconds in view of manufacturing efficiency.

<Stretching Process>

The manufacturing method of the present invention may include a process of stretching the peelable laminated film formed after the film-forming process. In the manufacture of the peelable laminated film of the present invention, it is preferred to stretch the peeled web (peelable laminated film) peeled off from the casting support when a residual solvent amount in the web is less than 120% by mass.

Further, the residual solvent amount may be represented by the following equation.

Residual solvent amount (% by mass)={(M−N)/N}×100

Here, M is a mass of the web at any time point, and N is a mass when the web with M measured is dried at 110° C. for 3 hours. When the residual solvent amount in the web is excessively high, it is impossible to obtain a stretching effect, and when the amount is too low, it becomes significantly difficult to perform stretching, and thus, the web may break in some cases. The residual solvent amount in the web is more preferably 10% by mass to 50% by mass, and particularly, most preferably 12% by mass to 35% by mass. Further, when a stretching magnification is excessively low, it is impossible to obtain a sufficient phase difference, and when the stretching magnification is excessively high, it becomes significantly difficult to perform stretching, and thus the web may break in some cases.

The stretching magnification may be generally set to 5% to 100%, and also preferably to 15% to 40%. Here, stretching in one direction by 5% to 100% means that a distance between clips or pins to support the peelable laminated film is maintained in a range of 1.05 times to 2.00 times the distance therebetween before stretching.

Further, stretching may be performed in a conveying direction (machine direction) of the peelable laminated film or in a direction (transverse direction) orthogonal to the conveying direction of the peelable laminated film, or in both directions.

In the invention, a film formed by a solution casting film-formation may be stretched even though not heated at a high temperature as long as the residual solvent amount falls within a specific range, which is preferred because the process is completed in a short period of time when the process includes drying and stretching. In the invention, the stretching temperature in the stretching process is preferably 110° C. to 190° C., and more preferably 120° C. to 150° C. The stretching temperature is preferably 120° C. or more from the viewpoint of securing low haze, and is preferably 150° C. or less from the viewpoint of enhancing optical developability (from the viewpoint of thinning of the film).

Meanwhile, when a temperature of the web is too high, a plasticizer therein may evaporate away, and therefore, in the case where a volatile low-molecular plasticizer is used as a plasticizer, the temperature of the web is preferably within a range of room temperature (15° C.) to 145° C.

Further, stretching the film in biaxial directions orthogonal to each other is effective from the viewpoint of enhancing the optical developability of the film, and from the viewpoint of increasing a Rth (retardation) value of the film.

In the invention, the film may be stretched simultaneously in biaxial directions in the stretching process, or may be stretched sequentially in biaxial directions in the stretching process. When the film is stretched sequentially in biaxial directions, the stretching temperature may vary in every stretching in each direction.

When the film is stretched simultaneously in biaxial directions, the peelable laminated film of the present invention may be obtained even when stretched at the stretching temperature from 110° C. to 190° C., and the stretching temperature in simultaneous biaxial stretching is more preferably 120° C. to 150° C., and particularly preferably 130° C. to 150° C. Further, simultaneous biaxial stretching may increase the haze to some degree, but may further enhance the optical developability.

Meanwhile, in the case of sequential biaxial stretching, it is preferred that the peelable laminated film is first stretched in a direction parallel to the conveying direction of the peelable laminated film, and then in a direction orthogonal to the conveying direction of the peelable laminated film. A more preferred range of the stretching temperature in the sequential stretching is the same as the stretching temperature range for the aforementioned simultaneous biaxial stretching.

<Heat Treatment Process>

It is preferred that the method for manufacturing the peelable laminated film of the present invention includes a heat treatment process after the drying process is completed. The heat treatment in the heat treatment process may be performed after the drying process is completed, and may be performed immediately after the stretching/drying process, or after the drying process is completed and then winding is performed, only the heat treatment may be separately performed. In the present invention, it is preferred that cooling is performed from room temperature to 100° C. after the drying process is completed, and then the heat treatment is performed again. The reason is that it is advantageous in obtaining a peelable laminated film which is excellent in terms of heat dimensional stability. For the same reason, it is preferred that the residual solvent amount immediately before the heat treatment process is dried to be less than 2% by mass and preferably less than 0.4% by mass.

The heat treatment is performed by a method of blow-drying the peelable laminated film while being conveyed at a predetermined temperature or by a method of using a heating means such as a microwave oven.

The heat treatment is performed preferably at a temperature from 150° C. to 200° C., and more preferably at a temperature from 160° C. to 180° C. Further, the heat treatment is performed preferably for 1 minute to 20 minutes, and more preferably for 5 minutes to 10 minutes.

<Heated Water Vapor Treatment>

In addition, the peelable laminated film subjected to stretching treatment may be then manufactured by being subjected to process of spraying water vapor heated to 100° C. or more. A residual stress of the peelable laminated film to be manufactured is alleviated by subjecting the peelable laminated film to the water vapor spraying process, and the dimensional change is reduced, which is preferred. The temperature of water vapor is not particularly limited as long as the temperature is 100° C. or more, but in consideration of heat resistance of the peelable laminated film, the temperature of water vapor becomes 200° C. or less.

In the manufacturing method of the present invention, both ends of the peelable laminated film may be subjected to edge trimming. As the edge trimming method, it is possible to use a general technology such as a cutting method with a cutter such as a blade and a method of using laser.

It is preferred to have an edge portion collection process of cutting the edge portion of the peelable laminated film in a travelling direction of the film, and collecting the film as a raw material for a recycling polymer. Here, a width of the edge portion to be cut is preferably 10 mm to 500 mm.

As a laminate, the cut and collected peelable laminated film of the present invention may be used as a raw material for a recycling polymer as it is, and it is more preferred that in the laminate, a resin layer (layer A) including cellulose ester and a resin layer (layer B) including a resin (for example, a (meth)acrylic resin) capable of a solution film-formation different from cellulose ester are separated by a technique such as peeling. In the recycled polymer raw material, the content ratio of the other resin into one direction due to contamination is preferably 20% or less. The ratio is more preferably 10% or less.

<Collection of Bulk Roll>

The peelable laminated film of the present invention may be collected as a bulk roll and used as a raw material for recycling when the film is prepared as a roll form having a length of 50 m or more, and then a problem occurs in terms of a winding shape or a surface shape. In this case, like the collection of the edge portion, the laminate may be collected as it is, and each layer may be separated by a technique such as peeling, and collected. In the recycled raw material, the content ratio of the other resin into one resin due to contamination is preferably 20% or less, and more preferably 10% or less.

A peelable laminated film roll may be obtained by winding the peelable laminated film obtained by being subjected to the aforementioned processes as it is.

Further, a part of the layers of the peelable laminated film may be peeled off, and the peeled layers may be wound as individual films. The peeling method will be described below.

For example, a long cellulose ester film may be obtained by winding the layer A peeled off from the peelable laminated film as a cellulose ester film. The long cellulose ester film may be used as a polarizing plate protective film as it is. Here, the term “long-sized” is not particularly limited as long as a length in a longitudinal direction is 5 m or more, and the length is preferably 100 m or more, and more preferably 1,000 m to 300,000 m in terms of manufacturing process.

<Surface Treatment Process>

When the film peeled off from the peelable laminated film of the present invention is used as a protective film of a polarizing plate, and then is adhered to a polarizer, it is preferred that a treatment of making the surface thereof hydrophilic is performed, such as acid treatment, alkali treatment, plasma treatment, and corona treatment, from the viewpoint of the adhesiveness of the film to the polarizer.

Among them, since the peelable laminated film of the present invention has the layer A of a cellulose acylate, it is preferred that the layer A of the cellulose acylate is alkali-saponified, thereby improving the adhesiveness thereof to a polarizer of polyvinyl alcohol typically used. Without the layer A, it is necessary to use an adhesion bond, which is disadvantageous because the production efficiency deteriorates.

<Peeling Method of Each Layer from Peelable Laminate>

Each layer may be peeled off from the peelable laminated film (peelable laminate) beginning from physical folding, burring from a cut edge face, heat, moist-heat treatment and the like.

It is possible to use a method of using a difference in physical and mechanical properties (ductility and toughness) between the layers of the peelable laminated film, a method of using a difference in physical change such as dimensional change due to heat and moist-heat treatment, and a method of using a difference in shear rates in upper and lower film thickness directions, and these methods may be appropriately differentiated and used according to properties of the peelable laminated film. Even when the difference in dimensional change due to heat and moist-heat dimension is used, a local change is produced by applying a heating roll or heated water vapor to a desired site during the peeling, and as a result, a difference in amount of displacement for each layer functions as a shear force, and when the force exceeds interlayer adhesion, peeling occurs.

Further, a plurality of films may also be simultaneously obtained from the peelable laminated film of the present invention, but the film may also be used while being wound as a laminate as it is and appropriately peeled off. When the formed layer is very thin, it is preferred that the laminate is handled as it is and processed from the viewpoint of portability.

In the present invention, the peeled layer A may be used as a thin cellulose ester film. It is preferred that the film is used as an optical film. Similarly, the peeled layer B may also be preferably used as an optical film of the resin other than cellulose ester.

<Physical Properties of Peeled Film>

(Optical Properties)

A light transmittance of the peeled cellulose ester film is preferably 80% or more, and more preferably 86% or more. Further, a haze of the cellulose ester film is preferably 2.0% or less, and more preferably 1.0% or less.

[Elastic Modulus].

An elastic modulus of the peeled cellulose acetate film is preferably 1,000 MPa to 8,000 MPa, and more preferably 2,000 MPa to 6,000 MPa.

(Degree of Orientation)

As for a degree of orientation of the peeled cellulose ester film, it is preferred that a degree of orientation (P1) of cellulose ester in a surface direction satisfies 0≦|P1|≦0.20. More preferably, 0≦|P1|≦0.10, and particularly preferably, 0≦P1|≦0.05. The degree of orientation may be obtained by a method described in Japanese Patent Application Laid-Open No. 2008-260921.

(Delamination Property)

When the peeled cellulose ester film is used as an optical film, delamination (fractures in a peeling test) inside the optical film is small in a more preferred aspect. A size of the delamination may be quantified by a width of a stem of a peeled portion derived from delamination produced when measured by a specific method, and the delamination in the present specification refers to a value observed and measured based on the description of [0030] of Japanese Patent Application Laid-Open No. H9-185148. Practically, the delamination is preferably 300 μm or less, more preferably 200 μm or less, and particularly preferably 100 μm or less.

When the delamination is 280 μm or less, it is difficult for fractures to be produced in the film during a rework operation of a liquid crystal display panel, and thus it is less likely that loss in manufacturing costs occurs, which is preferred. Further, in the present specification, the rework operation refers to an operation in which in the case where an error occurs when a polarizing plate is adhered to a glass substrate of a liquid crystal display device, the polarizing plate is peeled off once from the glass substrate for the purpose of repairing the display by adhering the polarizing plate to the glass substrate again.

That is, among the films of the present invention, when an optical film having a more preferred aspect is used, reworkability of the liquid crystal display device of the present invention is enhanced, which is preferred from the viewpoint of manufacturing costs.

(Smoothness of Film Surface and Peeled Surface)

It is preferred that the peelable laminated film of the present invention, the layer A including a cellulose ester peeled off from the peelable laminated film, and the layer B composed of a resin capable of a solution film-formation different from the cellulose ester have a smooth film surface from the viewpoint of uniformity as an optical film.

The smoothness of the film surface may be evaluated as an arithmetic average roughness (Ra) based on JIS B0601:2001 and ISO 4287:1997 using a surface roughness measuring device (manufactured by Kosaka Laboratory Ltd.).

A preferred arithmetic average roughness (outside of Ra) of a surface at an air interface (air surface) side, which is an outermost layer surface of the peelable laminated film, and a surface at a support surface side during the film formation is 0.05 μm or less on any surface, more preferably 0.03 μm or less, and particularly preferably 0.02 μm or less.

A preferred arithmetic average roughness (within Ra) of a surface on which the layer A and the layer B are peeled off is 0.2 μm or less, more preferably 0.1 μm or less, and particularly preferably 0.05 μm or less.

(Contact Angle of Film Surface)

It is preferred that the film surfaces of the peelable laminated film of the present invention, the layer A including a cellulose ester peeled off from the peelable laminated film, and the layer B composed of a resin capable of a solution film-formation different from the cellulose ester have appropriate hydrophobicity from the viewpoint of processing such as surface treatment or adhesion as a liquid crystal display member.

The hydrophobicity may be approximately evaluated by measuring a contact angle of the film surface. The measurement of a contact angle may be evaluated by measuring a contact angle of water drops by a sliding method using a contact angle meter (manufactured by Kyowa Interface Science Co., Ltd.).

A preferred contact angle of the surface at the air interface (air surface) side, which is the outermost layer surface of the peelable laminated film, and the surface at the support surface side during the film formation is 40 degrees to 100 degrees on any surface, more preferably 45 degrees to 90 degrees, and particularly preferably 50 degrees to 80 degrees.

A preferred contact angle of a surface on which the layer A and the layer B are peeled off is in a range of 40 degrees to 120 degrees, more preferably in a range of 45 degrees to 110 degrees, and particularly preferably 50 degrees to 100 degrees. When the contact angle is less than 120 degrees, processability such as adhesion to a polarizer is enhanced when the peelable laminated film is used as a polarizing plate protective film, which is preferred.

(Peeling Electrification)

It is preferred that the peelable laminated film of the present invention, the layer A including a cellulose ester peeled off from the peelable laminated film, and the layer B composed of a resin capable of a solution film-formation different from the cellulose ester have a small electric charge amount on the surface of the film from the viewpoint of dust protection property. For the surface of the peelable laminated film and the film peeled off from the peelable laminated film, a vertical peeling electrification measured at normal temperature and normal moisture is preferably −200 pc (picocoulomb)/cm² to +200 pc (picocoulomb)/cm². The vertical peeling electrification is more preferably −100 pc/cm² to +200 pc/cm², still more preferably −50 pc/cm² to +50 pc/cm², and most preferably 0 pc/cm². Here, the unit pc (picocoulomb) is 10⁻¹² couloumb. More preferably, the vertical peeling electrification measured at normal temperature and 10% RH is −100 pc/cm² to +100 pc/cm², still more preferably −50 pc/cm² to +50 pc/cm², and most preferably 0 pc/cm².

The vertical peeling electrification may be measured by a method described in Japanese Patent No. 3847130.

(Retardation)

In the present specification, Re (λ nm) and Rth (λ nm) represent an in-plane retardation and a retardation in a thickness-direction at a wavelength of λ (unit; nm), respectively. Re (λ nm) is measured by making light having a wavelength of λ nm incident in a normal direction of the film using KOBRA 21ADH (manufactured by Oji Scientific Instruments Co., Ltd.).

When a film to be measured is represented by a uniaxial or biaxial refractive ellipsoid, Rth (λ nm) is calculated by the following method.

A total of six points of the Re (λ nm) are measured by making light having a wavelength of 1 nm incident from each of the inclined directions at an angle increasing in 10° step increments up to 50° in one direction from the normal direction of the film by taking an in-plane slow axis (determined by KOBRA 21ADH) as an inclined axis (axis of rotation) (when there is no slow axis, any in-plane direction of the film will be taken as an axis of rotation), and then Rth (λ nm) is calculated by KOBRA 21ADH based on the retardation value measured, the average refractive index, and the film thickness value inputted.

When λ is not particularly described and only described with Re and Rth in the above description, λ indicates λ having values measured by using light having a wavelength of 590 nm. Further, in the case of a film having a direction in which a retardation value is zero at a certain inclined angle in the normal direction about the in-plane slow axis as an axis of rotation, a retardation value at an inclined angle larger than that the certain inclined angle is changed into a minus sign, and then is calculated by KOBRA 21ADH.

Further, the Rth may also be calculated based on two retardation values measured in any two inclined directions by taking the slow axis as an inclined axis (axis of rotation) (when there is no slow axis, any in-plane direction of the film will be taken as an axis of rotation), the average refractive index, and the film thickness inputted and from the following Formulas (3) and (4).

$$Re ( θ ) = [ nx - \frac{ny \times nz}{\sqrt{\begin{matrix}{\{ ny sin ( {sin}^{- 1} ( \frac{sin ( - θ )}{nx} ) ) \}}^{2} + \\ {\{ nz cos ( {sin}^{- 1} ( \frac{sin ( - θ )}{nx} ) ) \}}^{2}\end{matrix}}} ] \times \frac{d}{cos \{ {sin}^{- 1} ( \frac{sin ( - θ )}{nx} ) \}} \qquad Formula ( 3 )$$

[In the formula, Re (θ) represents a retardation value in a direction inclined by an angle (θ) from the normal direction. Further, nx represents a refractive index in an in-plane slow axis direction; ny represents a refractive index in an in-plane direction orthogonal to nx, nz represents a refractive index in a thickness direction orthogonal to nx and ny, and d is a film thickness.]

Rth=((nx+ny)/2−nz)×d Formula (4)

When a film to be measured may not be represented by a uniaxial or biaxial refractive ellipsoid, so-called, when the film has no optic axis, Rth (λ nm) is calculated by the following method.

Eleven points of the Re (λ nm) are measured by making light having a wavelength of λ nm incident from each of the inclined directions at an angle increasing in 10° step increments from −50° to +50° in one direction from the normal direction of the film by taking the in-plane slow axis (determined by KOBRA 21ADH) as an inclined axis (axis of rotation), and then Rth (λ nm) is calculated by KOBRA 21ADH based on the retardation value measured, the average refractive index, and the film thickness value inputted. KOBRA 21ADH calculates nₓ, n_{y} and n_{z} by inputting these average refractive index values and the film thickness thereinto. From the calculated nx, ny, and nz, Nz=(nx−nz)/(nx−ny) is further calculated.

Further, in the aforementioned measurements, values described in Polymer Handbook (John Wiley & Sons, Inc.) and catalogues of various optical films may be used as the average refractive index. The average refractive index of which value is not already known may be measured by the above-described method. Main values of average refractive indices of optical films are illustrated below: Cellulose acylate (1.48), cycloolefin polymer (1.52), polycarbonate (1.59), polymethyl methacrylate (1.49) and polystyrene (1.59).

[Polarizing Plate]

A polarizing plate of the present invention includes a polarizer and the optical film of the present invention.

The optical film of the present invention may be used as a protective film in a polarizer and a polarizing plate having a protective film disposed at at least one side thereof.

Further, as a configuration of the polarizing plate, in a form in which a protective film is disposed on both surfaces of the polarizer, the optical film of the present invention may also be used as a protective film at one side or a phase difference film.

Examples of the polarizer include an iodine-based polarization film, a dye-based polarization film using a dichroic dye, or a polyene-based polarization film. The iodine-based polarization film and the dye-based polarization film may be generally manufactured by using a polyvinyl alcohol-based film.

[Manufacturing Method of Polarizing Plate Using Peelable Laminate]

As the peelable laminate, a three-layered configuration composed of the layer A composed of cellulose, which is outer layers at both sides of the layer B to be an inner layer as a conveying support, or the A layer which is one of the outer layers and the other layer C is preferred because the polarizing plate may be efficiently manufactured using the peelable laminate.

The layer A (layer C) at both sides of the layer B from the layer B may be peeled off simultaneously or subsequently by the aforementioned peeling method, and the polarizer is sandwiched between two layers after the peeling, thereby preparing a polarizing plate using the two layers as a protective film.

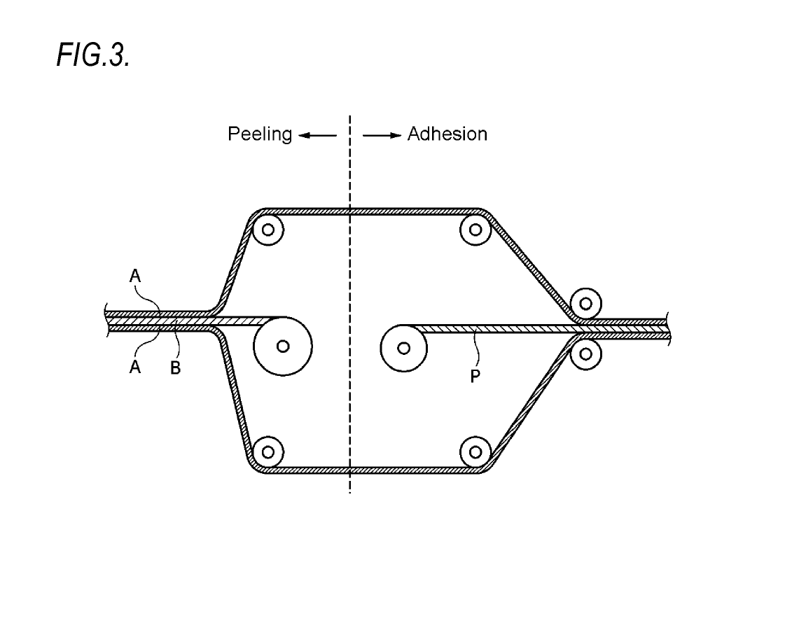

FIG. 3 schematically illustrates an example of the manufacturing process of the polarizing plate. As described in FIG. 3, adhesion may be performed by peeling off the layer A (one side may also be the layer C) at both sides of the layer B, continuously conveying the peeled layer A, and sandwiching a polarizer P therebetween. In this case, even though being very thin, the layer A and the layer C are thick as the laminate, and thus difficulties of various manipulations are low because surface processing or imparting of a coating layer may be handled similarly as in a typical thick film, and a thin-type polarizing plate thinned may be manufactured as a protective film without significantly impairing portability or manufacturing suitability until the subsequent manufacturing process of the polarizing plate, and thus this case may be used as an example which may be preferably applied as a utilization method of the peelable laminate of the present invention.

Here, when the layer A and the layer B are subjected to saponification treatment as a peelable laminated film prior to peeling off the layer A and the layer B, only the outermost layer of the layer A is saponified. In this case, in order to adhere a saponified surface of the peeled layer A to the polarizer, the saponified surface may be adhered to the polarizer conveyed from the outer side, or may be adhered to the polarizer conveyed from the inner side by conveying the (front and back) of the peeled layer A while being twisted when the polarizer is conveyed.

Further, the layer A after being peeled off may be subjected to saponification treatment.

In addition, the layer A side in the peelable laminated film is adhered in advance to the polarizer, and then the layer B may be peeled off from the layer A adhered to the polarizer.

As a method of adhering a protective film to the polarizer, an aqueous adhesive or adhesion bond may be used, and an acryl-based, or epoxy-based and urethane-based adhesive may be used.

[Liquid Crystal Display Device]

A liquid crystal display device of the present invention uses the optical film of the present invention or the polarizing plate of the present invention.

The optical film and the polarizing plate may be advantageously used in an image display device such as a liquid crystal display device, and is preferably used in a topmost layer at a backlight side.

In general, the liquid crystal display device has a liquid crystal cell and two polarizing plates disposed at both sides thereof, and the liquid crystal cell carries a liquid crystal between two electrode substrates. Further, one optically anisotropic layer is disposed between the liquid crystal cell and one polarizing plate, or two optically anisotropic layers are disposed between the liquid crystal cell and both polarizing plates in some cases.

For the liquid crystal cell, a TN mode, a VA mode, and an OCB mode, an IPS mode or an ECB mode is known, but the liquid crystal cell may be used preferably for a liquid crystal display device of any operation mode.

### EXAMPLES

Hereinafter, characteristics of the present invention will be described in more detail with reference to Examples.

Materials, use amounts, ratios, treatment matters, treatment sequences and the like shown in the following Examples may be appropriately modified as long as not departing from the spirit of the present invention. Therefore, the scope of the present invention should not be construed as being limited by the specific examples shown below.

Further, unless particularly specified, “parts” are based on mass.

[Measurement Method]

<Measurement Conditions of Weight Average Molecular Weight>

The weight average molecular weight is measured by gel permeation chromatography. The measurement conditions are as follows.

Solvent: Tetrahydrofuran

Device name: TOSOH HLC-8220GPC

Column: Three columns of TOSOH TSKgel Super HZM-H (4.6 mm×15 cm) are connected and used.

Column temperature: 25° C.

Sample concentration: 0.1% by mass

Flow rate: 0.35 ml/min

Calibration curve: Calibration curves made with 7 samples of TSK standard polystyrene manufactured by TOSOHI Corporation (Mw=2,800,000 to 1,050) are used.

<Solubility Parameter (SP Value)>

As a solubility parameter, the solubility parameter described in J. Brandrup, E. H, et al., “Polymer Handbook (4th Edition)”, VII/671 to VII/714 is used.

An SP value of each polymer is shown in the following Table 1. Table 2 describes a difference in SP values between two polymers used.

(Adhesion)

An adhesion of a peelable laminated film was measured by the following 90 degree peeling test method.

1. Through an adhesive, a co-cast film is adhered to a glass plate, and the peelable laminated film is adhered on the co-cast film. For example, a layer A including cellulose ester is toward the glass plate side (downward), and a layer B including a resin capable of a solution film-formation different from the cellulose ester is upward.

A size of a test sample is width 1 cm×length 15 cm, and a length of an adhered portion is 7 cm.

2. At an interface of the peelable laminated film, the layer B is pulled out in a 90 degree direction to cause an interfacial peeling to proceed, thereby peeling off only an end of the peelable laminated film. A load at this time is measured, and the obtained value is defined as an adhesion.

(Surface Shape of Film)

A thickness unevenness (R stepped unevenness and wind unevenness) of the film was observed under the polarizing plate cross Nichol, and evaluated in accordance with the following standards.

A: Thickness unevenness is not visually recognized

B: Very slight thickness unevenness is visually recognized

C: Slight thickness unevenness is visually recognized, but is negligible

D: Thickness unevenness is visually recognized as a clear unevenness.

(Retardation Uniformity)

An in-plane retardation and a retardation in a thickness-direction Re and Rth were measured (sample size 4 cm×4 cm) at a wavelength of 589 nm by KOBRA 21ADH (manufactured by Oji Scientific Instruments Co., Ltd.), an irregularity variation coefficient was calculated as a standard deviation/average value from an average value and a standard deviation obtained by performing measurement with 10 points in a longitudinal direction and a gap of 20 cm in a width direction, and evaluation was performed in accordance with the following standards.

A: Irregularity is less than 1.5%

B: Irregularity is 1.5% or more and less than 5%

C: Irregularity is 5% or more and less than 10%

D: Irregularity is 10% or more

### Example 1

### Manufacture of Dope

According to the composition in the following Table 1, a dope was manufactured.

In Table 1, a commercially available DIANAL BR88 manufactured by Mitsubishi Rayon Co., Ltd. was used as Acryl 1, and a commercially available DIANAL BR85 manufactured by Mitsubishi Rayon Co., Ltd. was used as Acryl 2.

The following compound was used as an additive A1. In the following structural formula, R represents a benzoyl group, and a compound having an average degree of substitution of 5 to 7 was used.

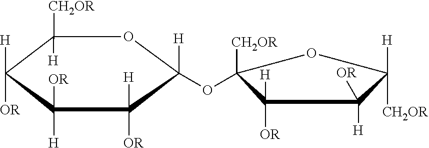

The following compound was used as an additive A2 (each structural formula and degree of substitution of R⁹ is described as follows).

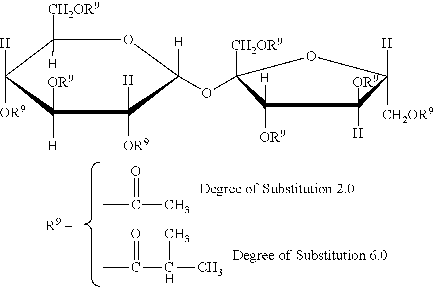

A condensate of adipic acid/ethylene glycol (number average molecular weight=1,000, uncapped end) was used as an additive A3.

L4258 of KURARAY CO., LTD., which is a block copolymer of butyl acrylate-methyl methacrylate, was used as an additive A4.

The following compound U1 was used as an additive U1.

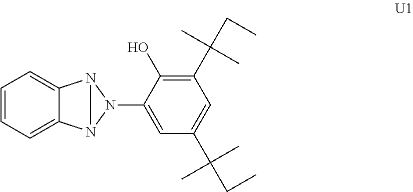 [SMILES: CCC(C)(C)c1cc(-n2n3c4ccccc4n23)c(O)c(C(C)(C)CC)c1]

The following compound U2 was used as an additive U2.

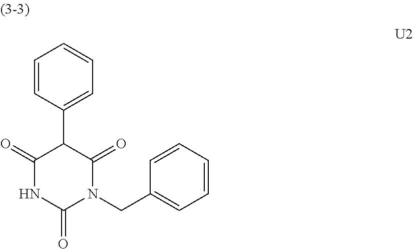 [SMILES: O=C1NC(=O)N(Cc2ccccc2)C(=O)C1c1ccccc1]

The following compound U3 was used as an additive U3.

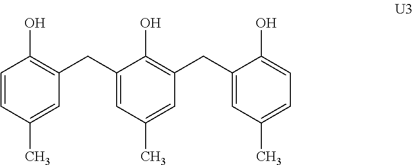 [SMILES: Cc1ccc(O)c(Cc2cc(C)cc(Cc3cc(C)ccc3O)c2O)c1]

The following compound U4 was used as an additive U4.

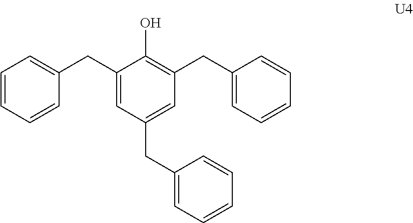 [SMILES: Oc1c(Cc2ccccc2)cc(Cc2ccccc2)cc1Cc1ccccc1]

TABLE 1

| | | | Degree of Substitution (DS) | | | | | | | | | |
|---|---|---|---|---|---|---|---|---|---|---|---|---|
| | | | of Cellulose Acylate | | | | | | | | | |
| | Polymer | | | DS by | DS by | | Additive 1 | | Additive 2 | | Additive 3 | |
| Dope | | Weight average | Total DS | acetyl | propiony | Polymer | | Amount | | Amount | | Amount |
| No. | Kind | molecular weight | (A + B) | (A) | (B) | SP value | Kind | % by mass | Kind | % by mass | Kind | % by mass |
| P10 | Acryl 1 | 1,500,000 | — | — | — | 19.4 | A1 | 5.8 | A2 | 1.8 | U1 | 2 |
| P11 | Acryl 1 | 1,500,000 | — | — | — | 19.4 | A3 | 15 | — | — | — | — |
| P12 | Acryl 1 | 1,500,000 | — | — | — | 19.4 | A4 | 5 | — | — | — | — |
| P13 | Acryl 1 | 1,500,000 | — | — | — | 19.4 | — | — | — | — | — | — |
| P14 | Acryl 2 | 350,000 | — | — | — | 19.4 | — | — | — | — | — | — |
| P20 | PC | 1,000,000 | — | — | — | 20.3 | — | — | — | — | — | — |
| P30 | PS | 1,000,000 | — | — | — | 19.4 | — | — | — | — | — | — |
| T10 | CA-1 | 200,000 | 2.86 | 2.86 | — | 21.9 | A1 | 5.8 | A2 | 1.8 | U1 | 2 |
| T11 | CA-1 | 200,000 | 2.86 | 2.86 | — | 21.9 | A3 | 15 | — | — | — | — |
| T12 | CA-1 | 200,000 | 2.86 | 2.86 | — | 21.9 | A1 | 5.8 | A2 | 1.8 | U2 | 4 |
| T13 | CA-1 | 200,000 | 2.86 | 2.86 | — | 21.9 | A1 | 5.8 | A2 | 1.8 | U3 | 4 |
| T14 | CA-1 | 200,000 | 2.86 | 2.86 | — | 21.9 | A1 | 5.8 | A2 | 1.8 | U4 | 4 |
| T20 | CA-2 | 200,000 | 2.86 | 2.81 | — | 22.0 | A1 | 5.8 | A2 | 1.8 | U1 | 2 |
| T30 | CA-3 | 200,000 | 2.42 | 2.42 | — | 22.7 | A1 | 5.8 | A2 | 1.8 | U1 | 2 |
| T40 | CA-5 | 200,000 | 2.65 | 0.18 | 2.47 | 21.6 | A1 | 5.8 | A2 | 1.8 | U1 | 2 |

In Table 1, PC, PS and CA-1 to CA-5 indicate polycarbonate (general PANLITE manufactured by Teijin Chemicals Ltd.), polystyrene and cellulose acylate, respectively.

In Table 1, the amount of additives 1, 2 and 3 is a ratio (% by mass) with respect to a polymer.

<Conditions of Film-Formation>

A solution casting film-formation was performed using a dope described in Table 1, thereby manufacturing a peelable laminated film so as to have a configuration in the following Table 2. Specifically, the film was passed through a casting Giesser capable of a three-layer co-casting, and casting was performed on a metal support so as to have a layer configuration as described in Table 2. In this case, casting was performed so as to sequentially form a lower side layer, an intermediate layer and an upper side layer from a metal support surface side, and a viscosity of each layer was set so as to be in a state capable of uniform casting by appropriately adjusting a concentration of a solid content according to the combination of dopes so as to enable co-casting. While the film was present on the metal support, the dope was dried with a drying wind at 40° C. to form a peelable laminated film, and then the film was peeled off and dried with a drying wind at 105° C. for 5 minutes while maintaining the gap at the same interval by fixing both ends of the peelable laminated film with pins. The pins were removed and then the film was further dried at 130° C. for 20 minutes to wind the film in a laminated film state.

The film characteristics of the upper side layer and the lower side layer each indicate the characteristics of the peelable film after the peelable laminated film was peeled off onto each layer (Table 2).

TABLE 2

| | | | | Film thickness | | | | | |
|---|---|---|---|---|---|---|---|---|---|
| | Upper side | Intermediate | Lower side | Sum | Upper side | Intermediate | Lower side | Peel force | Difference in |
| Sample No. | layer | layer | layer | [μm] | layer [μm] | layer [μm] | layer [μm] | [N/cm] | SP value |
| Comparative 1 | — | — | T10 | 10 | — | — | 10 | — | — |
| Comparative 2 | — | — | T10 | 20 | — | — | 20 | — | — |
| Comparative 3 | — | — | T10 | 30 | — | — | 30 | — | — |
| Comparative 4 | — | — | T10 | 40 | — | — | 40 | — | — |
| Comparative 5 | T10 | T10 | T10 | 60 | 20 | 20 | 20 | Not peelable | 0.0 |
| Comparative 6 | T20 | T10 | T20 | 60 | 20 | 20 | 20 | 7 | 0.1 |
| 101 | — | P10 | T10 | 30 | — | 20 | 10 | 0.3 | 2.5 |
| 102 | — | P10 | T10 | 60 | — | 40 | 20 | 0.4 | 2.5 |
| 201 | T10 | P10 | T10 | 40 | 10 | 20 | 10 | 0.4 | 2.5 |
| 202 | T10 | P10 | T10 | 60 | 20 | 20 | 20 | 0.4 | 2.5 |
| 203 | T10 | P10 | T10 | 80 | 30 | 20 | 30 | 0.7 | 2.5 |
| 204 | T10 | P10 | T10 | 100 | 40 | 20 | 40 | 1.6 | 2.5 |
| 205 | T10 | P10 | T10 | 70 | 30 | 20 | 20 | 0.7 | 2.5 |
| 206 | T10 | P10 | T10 | 180 | 60 | 60 | 60 | 3.0 | 2.5 |
| Reference 1 | T10 | P14 | T10 | 60 | 20 | 20 | 20 | 4.0 | 2.5 |
| 301 | T10 | P13 | T10 | 60 | 20 | 20 | 20 | 0.4 | 2.5 |
| 302 | T10 | P12 | T10 | 60 | 20 | 20 | 20 | 0.2 | 2.5 |
| 303 | T10 | P20 | T10 | 60 | 20 | 20 | 20 | 1.8 | 1.6 |
| 304 | T10 | P30 | T10 | 60 | 20 | 20 | 20 | 1.5 | 2.5 |
| 401 | T11 | P11 | T11 | 60 | 20 | 20 | 20 | 0.4 | 2.5 |
| 402 | T20 | P10 | T20 | 60 | 20 | 20 | 20 | 0.4 | 2.6 |
| 403 | T30 | P10 | T30 | 60 | 20 | 20 | 20 | 0.3 | 3.3 |
| 404 | T40 | P10 | T40 | 60 | 20 | 20 | 20 | 0.3 | 2.2 |
| 405 | T10 | P10 | T11 | 60 | 20 | 20 | 20 | 0.5 | 2.5 |
| 406 | T11 | P10 | T10 | 60 | 20 | 20 | 20 | 0.5 | 2.5 |
| 407 | T12 | P10 | T12 | 60 | 20 | 20 | 20 | 0.4 | 2.5 |
| 408 | T13 | P10 | T13 | 60 | 20 | 20 | 20 | 0.4 | 2.5 |
| 409 | T14 | P10 | T14 | 60 | 20 | 20 | 20 | 0.4 | 2.5 |

| | Upper side layer | | | | Lower side layer | | | |
|---|---|---|---|---|---|---|---|---|
| | | | Surface | Retardation | | | Surface | Retardation |
| Sample No. | Re | Rth | shape | uniformity | Re | Rth | shape | uniformity |
| Comparative 1 | — | — | — | — | — | — | — | — |
| Comparative 2 | — | — | — | — | 0.6 | 25 | D | D |
| Comparative 3 | — | — | — | — | 0.5 | 30 | D | C |
| Comparative 4 | — | — | — | — | 0.4 | 35 | B | B |
| Comparative 5 | — | — | — | — | 0.2 | 40 | B | B |
| Comparative 6 | 0.2 | 30 | D | D | 0.2 | 30 | D | D |
| 101 | — | — | — | — | 0.2 | 16 | B | A |
| 102 | — | — | — | — | 0.2 | 16 | B | A |
| 201 | 0.2 | 15 | B | A | 0.2 | 16 | B | A |
| 202 | 0.2 | 18 | A | A | 0.2 | 18 | A | A |
| 203 | 0.2 | 21 | A | A | 0.2 | 20 | A | A |
| 204 | 0.2 | 25 | A | B | 0.2 | 26 | A | B |
| 205 | 0.2 | 21 | A | A | 0.2 | 18 | A | A |
| 206 | 0.2 | 30 | A | B | 0.2 | 31 | A | B |
| Reference 1 | 0.2 | 19 | A | C | 0.2 | 19 | C | C |
| 301 | 0.2 | 18 | C | A | 0.2 | 18 | A | A |
| 302 | 0.2 | 18 | A | A | 0.2 | 18 | A | A |
| 303 | 0.2 | 18 | A | B | 0.2 | 18 | A | B |
| 304 | 0.2 | 18 | A | B | 0.2 | 18 | A | B |
| 401 | 0.2 | −3 | A | A | 0.2 | −3 | A | A |
| 402 | 0.2 | 24 | A | A | 0.2 | 24 | A | A |
| 403 | 0.2 | 30 | A | A | 0.2 | 30 | A | A |
| 404 | 0.2 | 14 | A | A | 0.2 | 15 | A | A |
| 405 | 0.2 | 17 | A | A | 0.2 | −4 | A | A |
| 406 | 0.2 | −3 | A | A | 0.2 | 17 | A | A |
| 407 | 0.2 | 17 | A | A | 0.2 | 18 | A | A |
| 408 | 0.2 | 16 | A | A | 0.2 | 15 | A | A |
| 409 | 0.2 | 18 | A | A | 0.2 | 17 | A | A |

The case in which a thin film is manufactured without using the manufacturing method of the present invention is Comparisons 1 to 4, and the thin film of Comparison 1 having a thickness of 10 μm was not formed because the thin film fails to be conveyed. The films of Comparisons 2 and 3 having a thickness of 20 μm to 30 μm was able to manage to be conveyed, but a surface shape and retardation uniformity are insufficient. The film of Comparison 4 was a film capable of being conveyed and having good surface shape and retardation uniformity, but the thickness thereof was 40 μm. That is, it can be known that it is difficult to obtain a film having a thickness less than 40 μm and good surface shape and retardation uniformity when the present invention is not used.

In contrast, in the manufacturing method of the present invention, a thin film having a thickness of 10 μm was obtained by manufacturing a peelable laminated film, even the thin film was conveyed, and good surface shape and retardation uniformity were obtained (Samples 101 and 201). In addition, even from the thin film having a thickness of 20 μm to 30 μm, it is possible to obtain a sample having good surface shape and retardation uniformity (Samples 102, 202, 203, 301 to 304 and 401 to 409).

The higher the adhesion (peel force) is, the more the retardation uniformity tends to deteriorate. Further, Sample 302 is particularly excellent in peel force.

Further, even when drying was completed in a laminated state without peeling off the film, and peeling was performed immediately before winding, the characteristics in Table 2 was obtained.

[Manufacture of Polarizing Plate]

The peelable laminated films prepared in Examples and Comparative Examples was immersed in 4.5 mol/L of a sodium hydroxide aqueous solution (saponification liquid), temperature-controlled at 37° C. for 1 minute, washed, and then immersed in 0.05 mol/L of a sulfuric acid aqueous solution for 30 seconds, and also passed through a washing bath. Then, after repeating draining with an air knife three times to remove water, the film was dried by being allowed to stay in a drying zone at 70° C. for 15 seconds, thereby manufacturing a saponified peelable laminated film, and the upper layer and the lower layer were peeled off from the intermediate layer and conveyed, a polarizer was sandwiched therebetween such that the polarizer (polarizer having a thickness of 20 μm obtained by imparting a rim speed difference between two pairs of nip rolls, and performing stretching in a longitudinal direction in accordance with Example 1 of Japanese Patent Application Laid-Open No. 2001-141926) and saponified surfaces of the upper side layer and the lower side layer become the polarizer side, a roll-to roll adhesion was performed using a 3% aqueous solution of PVA (manufactured by KURARAY CO., LTD., PVA-117H) as an adhesion bond such that a polarization axis and a longitudinal direction of the film were parallel to each other, thereby preparing a polarizing plate. Any one polarizing plate had sufficient adhesibility with polyvinyl alcohol, and thus had excellent polarizing plate processing suitability. In addition, since the film was a thin film and laminated during saponification, a conveying property of the saponification process was also good, and there was no generation of tension or wrinkles, and the like during the processing of the polarizing plate. Further, since two films may be simultaneously saponified in the samples of three-layer lamination (201 to 206, 301 to 304 and 401 to 409), enhancement of productivity was also achieved.

### Example 2

### Evaluation of Polarizing Plate

For the polarizing plates using the peelable laminated films of the samples (202, 407, 408 and 409) prepared above, an orthogonal transmittance of the polarizer was measured at a wavelength of 410 nm and 510 nm.

Thereafter, for each of a sample stored under an environment of 60° C. and relative humidity 95% for 800 hours and a sample stored at 105° C. without humidity control for 50 hours, the orthogonal transmittance was measured by the same technique. A change in orthogonal transmittances was obtained before and after the passage of time and was used as polarizer durability, changes in orthogonal transmittances of the polarizing plates using the samples (202, 407, 408 and 409) were each 0.22%, 0.100%, 0.11% and 0.09% in the wet conditions and 0.00%, 0.00%, 0.00%, and 0.00% in the dry conditions, and particularly, the wet durability of the polarizing plates of the samples (407, 408 and 409) was excellent.

### Example 3

### Mounting on IPS Type Liquid Crystal Display Device

A polarizing plate with a liquid crystal cell disposed therebetween was peeled off from a commercially available liquid crystal television (42 type liquid crystal television of IPS mode), polarizing plates 405, and 406 (polarizing plates using the peelable laminated films of Samples 405 and 406) manufactured in Example 1 were adhered again to the liquid crystal cell through an adhesive such that a cellulose ester film T11 side was disposed at the liquid crystal cell side and a T10 side was the outer side, the performance and display performance of the commercially available product were compared, and thus a good display performance was obtained.

### Example 4

### Mounting Experiment on TN Mode Monitor

(Manufacture of Peelable Laminated Film 410)

The following compound C as a retardation developer was added to a dope of an upper side layer and a lower side layer in a peelable laminated film 407 manufactured in Example 1 so as to be present in an amount of 2.0 parts by mass based on 100 parts by mass of cellulose acylate, thereby manufacturing a peelable laminated film 410 in the same manner as in Example 1.

In the peelable laminated film 410 obtained, a residual solvent amount of the upper side layer and the lower side layer in the cellulose acylate film portions was less than 0.2%.

Exemplary Compound C

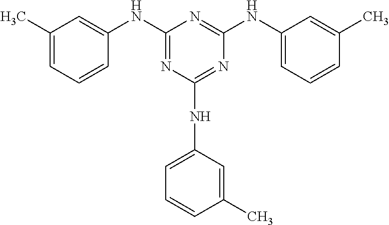

In the peelable laminated film 410, a Rth obtained by measuring the retardation of the cellulose acylate film of the upper side layer and the lower side layer by the method was 81 nm.

(Saponification Treatment)

5.2 ml/m² of a liquid having the following composition was applied on the peelable laminated film 410 manufactured above, and dried at 60° C. for 10 seconds. The surface of the peelable laminated film was washed with running water for 10 seconds, and dried by spraying air at 25° C. thereto.

<Composition of Saponification Liquid>

| | |
|---|---|
| Isopropyl alcohol | 818 parts by mass |
| Water | 167 parts by mass |
| Propylene glycol | 187 parts by mass |
| Potassium hydroxide | 80 parts by mass |

(Formation of Oriented Film)

A coating solution having the following composition was applied at 24 ml/m² on the cellulose acylate film on the side of the upper layer of the saponified peelable laminated film 410 using a wire bar coater of #14. An oriented film was formed by drying with warm wind at 60° C. for 60 seconds and further with warm wind at 90° C. for 150 seconds.

Subsequently, the oriented film formed in a direction at 45 degrees to a slow axis of the cellulose acylate film was subjected to rubbing treatment.

<Composition of Oriented Film Coating Solution>

| | | |
|---|---|---|
| Modified polyvinyl alcohol having the following | 20 | parts by mass |
| structure | | |
| Water | 360 | parts by mass |
| Methanol | 120 | parts by mass |
| Glutaraldehyde (crosslinking agent) | 1.0 | parts by mass |

Modified polyvinyl alcohol

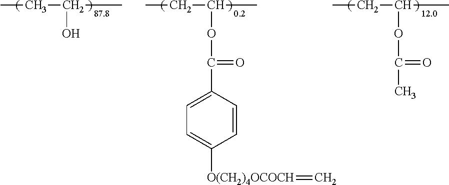

(Formation of Optically Anisotropic Layer and Manufacture of Optically Compensatory Film)

A coating solution in which 91 parts by mass of the following discotic liquid crystalline compound, 9 parts by mass of an ethylene oxide-modified trimethyolpropane triacrylate (V #360, manufactured by OSAKA ORGANIC CHEMICAL INDUSTRY LTD.), 1.5 parts by mass of cellulose acetate butyrate (CAB531-1, manufactured by Eastman Chemical Company), 3 parts by mass of a photopolymerization initiator (Irgacure 907, manufactured by Nihon Ciba-Geigy K.K.), 1 part by mass of a sensitizer (Kayacure DETX, manufactured by Nippon Kayaku Co., Ltd.) were dissolved in 214.2 parts by mass of methyl ethyl ketone was applied at 5.2 ml/m² on the oriented film using a wire bar coater of #3. The applied oriented film was adhered to a metal frame, and the resulting assembly was heated in a thermostat at 130° C. for 2 minutes, thereby orienting a discotic compound. Subsequently, UV rays were irradiated thereon at 90° C. using a high-pressure mercury lamp having 120 W/cm for 1 minute, thereby polymerizing the discotic compound. Thereafter, the assembly was allowed to cool down to room temperature. As described above, an optically anisotropic layer was formed, and a laminated peelable phase difference film 408 was manufactured.

Discotic Liquid-Crystalline Compound

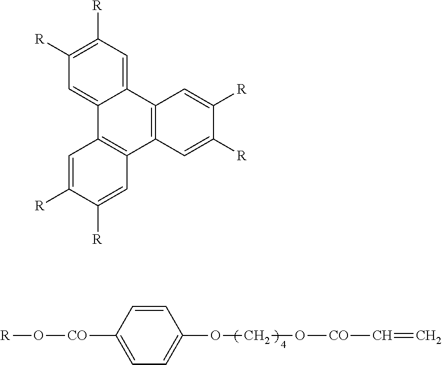

<<Manufacture of Polarizing Plate>>

The laminated peelable phase difference film 410 was saponified in the same conditions as in Example 1 by peeling off the peelable laminated film immediately before the saponification, and the peeled surface of which the upper layer and lower layer films were saponified was adhered to the polarizer, thereby manufacturing a polarizing plate.

<Evaluation of Viewing Angle>

A polarizing plate of an LA-1529HM type TFT-TN liquid crystal panel manufactured by NEC Corp. was peeled off, and an optically compensatory film provided between the polarizing plate and the liquid crystal panel was peeled off. For the polarizing plate sample manufactured by the above-described method, the laminated film was peeled off, provided and added such that the phase difference film side was between the polarizer and the liquid crystal panel. The polarizing plate was added on both a backlight side and an image observation surface side of the liquid crystal panel.

A monitor was driven by a personal computer, a contrast ratio during white/black display was measured using an Ez-Contrast from ELDIM Co., and with respect to upper and lower, and right and left sides, each angle of the liquid crystal panel showing a contrast of 10 or more from the radial direction was measured, and thus a good result of 40 degrees or more was obtained in any side of upper and lower, and right and left sides.

### INDUSTRIAL APPLICABILITY

According to the peelable laminated film, the film, the optical film and the manufacturing method of the polarizing plate of the present invention, it is possible to manufacture a film which is a thin film relatively easy and efficient in the range of the manufacturing technology in the related art and also has excellent surface shape or retardation uniformity and conveying property. In addition, it is possible to provide the obtained film as an optical film which may be applied to a polarizing plate or a liquid crystal display device.

Although the present invention has been described with reference to detailed and specific embodiments, it is obvious to those skilled in the art that various changes or modifications may be made without departing from the spirit and scope of the present invention.

The present application is based on Japanese Patent Application (Patent Application No. 2011-130722) filed on Jun. 10, 2011, Japanese Patent Application (Patent Application No. 2011-161327) filed on Jul. 22, 2011, and Japanese Patent Application (Patent Application No. 2012-130516) filed on Jun. 8, 2012, the contents of which are herein incorporated by reference.

What is claimed is:

1. A method for manufacturing a peelable laminated film, comprising:
simultaneously or sequentially casting and laminating a dope A for forming a layer A, which contains at least a cellulose ester and a solvent, and a dope B for forming a layer B, which contains at least a resin capable of a solution film-formation different from the cellulose ester and a solvent, on a casting support;
peeling off a laminate of the dope A and the dope B from the casting support; and
drying the laminate,
wherein the peelable laminated film includes the layer A containing the cellulose ester and the layer B containing the resin capable of a solution film-formation and different from the cellulose ester, the layer A and the layer B having an adhesion of 5 N/cm or less.

2. The method according to claim 1,
wherein a difference in SP value between the cellulose ester and the resin capable of a solution film-formation different from the cellulose ester is 0.2 or more.

3. The method according to claim 1,
wherein a three or more layer laminate is obtained by laminating any one layer or more of the dope A, the dope B and a dope C different from the dope A and the dope B on the laminate of the dope A and the dope B.

4. The method according to claim 1,
wherein the layer A has a film thickness of 5 μm to 60 μm, and
the peelable laminated film has a total film thickness of 20 μm to 200 μm.

5. The method according to claim 1,
wherein the cellulose ester used in the dope A is a cellulose acylate satisfying the following Equations (I) to (III):
1.0≦X+Y≦3.0 Equation (I)
0≦X≦3.0 Equation (II)
0≦Y≦2.6 Equation (III)
wherein, in Equations (I) to (III), X is a degree of substitution of a hydroxyl group in a glucose unit of the cellulose acylate by an acetyl group, and
Y is a degree of substitution of a hydroxyl group in a glucose unit of the cellulose acylate by an acyl group having 3 or more carbon atoms.

6. The method according to claim 1,
wherein the resin capable of a solution film-formation different from the cellulose ester, which is used in the dope B, is a (meth)acrylic resin.

7. The method according to claim 6,
wherein a (meth)acrylic resin used as a main component of the (meth)acrylic resin has a weight average molecular weight of 600,000 to 4,000,000.

8. The method according to claim 1,
wherein at least any one of the dopes, A, B and C contains a polarizer durability enhancer, and
the polarizer durability enhancer is a compound represented by following Formula (1): 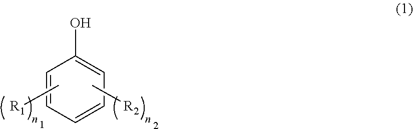
wherein, in Formula (1), R₁ represents a hydrogen atom or a substituent,
R₂ is a substituent represented by the following Formula (1-2),
n₁ represents an integer of 0 to 4, and each R₁ may be the same or different when n₁ is 2 or more, and
n2 represents an integer of 1 to 5, and each R² may be the same or different when n₂ is 2 or more: 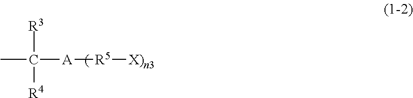
wherein, in Formula (1-2), A represents a substituted or unsubstituted aromatic ring,
R³ and R⁴ each independently represent a hydrogen atom, an alkyl group having 1 to 5 carbon atoms, or a substituent represented by Formula (1-3),
R⁵ represents a single bond or an alkylene group having 1 to 5 carbon atoms,
X represents a substituted or unsubstituted aromatic ring, and
n3 represents an integer of 0 to 10, and when n3 is 2 or more, each R⁵ may be the same or different and each X may be the same or different: 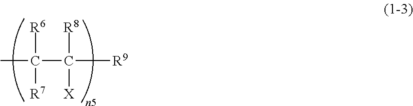
wherein, in Formula (1-3), X represents a substituted or unsubstituted aromatic ring,
R⁶, R⁷, R⁸ and R⁹ each independently represent a hydrogen atom or an alkyl group having 1 to 5 carbon atoms, and
n5 represents an integer of 1 to 11, and when n5 is 2 or more, each R⁶ may be the same or different, each R⁷ may be the same or different, each R⁸ may be the same or different, each R⁹ may be the same or different, and each X may be the same or different.

9. The method according to claim 1,
wherein a coating layer is formed on at least one surface of the laminate.

10. A method for manufacturing a peelable laminated film roll, comprising:
winding a peelable laminated film manufactured by the method according to claim 1.

11. A method for manufacturing a film, comprising:
peeling off a part of layers in a laminate of a peelable laminated film manufactured by the manufacturing method according to claim 1, and
winding each peeled layer as a separate film.

12. An optical film obtained by peeling off the layer A from a peelable laminated film by the manufacturing method according to claim 1.

13. A peelable laminated film comprising:
a laminate including a layer A containing a cellulose ester and a layer B containing a resin capable of a solution film-formation different from the cellulose ester, the layer A and the layer B having an adhesion of 5 N/cm or less.

14. The peelable laminated film according to claim 13,
wherein a difference in SP value between the layer B and the layer A is 0.2 or more.

15. The peelable laminated film according to claim 13,
wherein the laminate including the layer A and the layer B is a three or more-layer laminate including at least a plurality of either the layer A or the layer B, or a three or more-layer laminate including a layer C different from the layer A and the layer B.

16. The peelable laminated film according to claim 15,
wherein all of the three or more layers are different.

17. The peelable laminated film according to claim 13,
wherein the layer A has a film thickness of 5 μm to 60 μm, and
the peelable laminated film has a total film thickness of 20 μm to 200 μm.

18. The peelable laminated film according to claim 13,
wherein the layer B is a conveying support.

19. The peelable laminated film according to claim 13, further comprising a coating layer on at least one surface of the laminate.

20. A film obtained by peeling off any one layer of the laminate from the peelable laminated film according to claim 13.

21. A method for manufacturing a polarizing plate, comprising:
forming the peelabie laminated film according to claim 13 as a long-sized peelable laminated film and capable of being peeled off onto an inner layer and an outer layer of a front and back surface; and
peeling off the outer layer of the front and back surface of the peelable laminated film from the inner layer,
wherein a polarizer is sandwiched with the outer layer of the front and back surface.

22. A polarizing plate comprising an outer layer of the peelable laminated film according to claim 13, which is formed as a long-sized film and peelable onto an inner layer and the outer layer of a front and back surface, as a protective film of a polarizer.

23. A liquid crystal display device using the film according to claim 12.

24. A liquid crystal display device using the polarizing plate according to claim 22.
